(19) United States
(12) Patent Application Publication
(10) Pub. No.: US 2003/0154149 A1
(43) Pub. Date: Aug. 14, 2003

(54) System and method of creating and executing a restricted stock sale plan

(76) Inventor: Dilip Gajendragadkar, New York, NY (US)

Correspondence Address: Pennie & Edmonds, LLP, 3300 Hillview Avenue, Palo Alto, CA, 94304, US

(21) Appl. No.: 10/076,315

(22) Filed: Feb. 13, 2002

(51) Int. Cl. G06F 17/60

(52) U.S. Cl. 705/36

(57) ABSTRACT

The present invention relates generally to securities and in particular the creation and execution of sale plans regarding securities. More specifically, restricted stock information corresponding to a restricted stock is maintained in a database. A sale plan template is provided to the sale plan initiator in response to receiving from the sale plan initiator a request to create a sale plan. If the sale plan initiator is actually the broker acting on behalf of the holder, the sale plan is subsequently provided to the holder upon request for review and modification if necessary. The sale plan is subsequently provided to the broker for review. Following a review, the broker forwards the sale plan to the corporate counselor. If the corporate counselor does not find any problems, the sale plan is sent back to the broker for possible acceptance. An authorized person within the broker then accepts the sale plan following a final review if no problems are found. Notifications are then sent to the holder informing the holder that the sale plan has been accepted. Individual sales of the restricted stock, called for by the sale plan, are automatically and periodically initiated as specified by the sale plan.

The present invention relates generally to securities and in particular the creation and execution of sale plans regarding securities.

### BACKGROUND OF THE INVENTION

Stocks bought in the open market are held in book-entry forms and sold without restrictions. However, there are also classes of restricted stocks held by certain classes of individuals or institutions (“holders”) in companies that are subject to certain restrictions regarding the sale of such stocks. These restrictions are stated as legends on the stock certificates held by such holders. When such restricted stock is sold, the corporate counsel of the issuer of the stock has to write an opinion that instructs the transfer agent to remove the legend on the stock certificate. Pursuant to such an opinion, the transfer agent removes the legend and delivers clean, freely salable shares in book-entry or physical form to a brokerage firm that executes the sale of the stock. The settlement of the stock sale cannot be completed until the brokerage firm receives the clean shares. Then and only then, are the proceeds released to the holder. Examples of such restricted stocks include 1) stocks in issuers held by people deemed to be “insiders,” “control persons,” or “affiliates” of such issuers, 2) stock in private companies that has been held or in existence less than the statutorily required period of time, and 3) stocks issued as a result of mergers and acquisitions and registered under an S-3 prospectus etc.

The process used in selling such restricted stocks and removing the legends on these stock certificates is the most cumbersome, laborious and time-consuming process in the brokerage industry. Several different entities have to take actions for this process to be completed successfully. The action of each entity is dependent on the actions of the others. The settlement of the sale of such restricted stock can take as long as four weeks—in contrast to the three-day settlement process for sales of unrestricted stocks. For this long period, holders do not have access to the proceeds of their sales and the proceeds cannot be invested or earn interest.

Besides the loss of interest and lack of access to the proceeds, the holders and the brokerage firms are also subject to a risk called “buy-in-risk.” Because the holders are selling stocks that they cannot deliver to the buyers, the brokerage firms are often forced to borrow stocks in the market to make deliveries to the buyers of the stocks. Occasionally, depending on the supply and demand for such stocks, the brokerage firm may be forced to return the borrowed stocks to the lenders that lent the stocks to the brokerage firm. Buying the required number of stocks in the open market in the holders' account regardless of the price is the only way to do this. This can result in significant losses to the holders.

This existing process begins with the execution of certain documents by the holder who is selling restricted stocks. The brokerage firm executing the sale creates certain other documents. The internal counsel or other authority at the issuer has to approve the sale or make certain representations, and then send documentation of such to the law firm serving as the corporate counsel to the issuer. The corporate counsel then issues an opinion approving the sale and issues an instruction to the transfer agent to remove the restrictive legends and issue clean shares to the brokerage firm. The trade settles when the brokerage firm executing the sale receives such clean shares of the stocks.

For institutional holders such as venture capital firms, the process is doubly complicated. For these holders, the first step is to distribute their holdings to their partners (i.e., limited partners and general partners). This consists of taking one stock certificate held by a venture capital fund and breaking it down into stock certificates in the names of the partners of the venture capital fund. This process involves similar steps as the process described earlier and involves the issuance of a legal opinion by the issuer's counsel. Once this is done, each of the partners has to go through a process identical to the one described earlier to clean their shares and receive the proceeds of their sale.

Rule 10b5-1, issued by the Securities and Exchange Commission under the Securities Exchange Act of 1934, permits holders to establish a schedule of future stock sales (i.e., establish a sale plan). Individual sales specified in a sale plan do not violate insider-trading rules, even if a holder in question has material information when the trades actually take place. Insider trading liability generally applies to any holder who trades on the basis of material, nonpublic information in breach of a duty owed to the issuer, its shareholders or some other source of the information. The main feature of the rule, therefore, is that a holder commits to a sale plan when the holder does not have insider information. The trades that follow are thus independent of insider information. And like the manual process used in selling restricted stocks and removing the legends on these stock certificates, creating and executing such sale plans is cumbersome, laborious and time-consuming.

### SUMMARY OF THE INVENTION

The present invention relates generally to securities and in particular the creation and execution of sale plans regarding securities. More specifically, restricted stock information corresponding to a restricted stock is maintained in a database. The restricted stock information is accessible by a sale plan initiator, a holder, a broker, and a counselor. A sale plan template is provided to the sale plan initiator in response to receiving from the sale plan initiator a request to create a sale plan. The sale plan template includes information extracted from the restricted stock information. If the sale plan initiator is actually the broker acting on behalf of the holder, the sale plan is subsequently provided to the holder upon request for review and modification if necessary. The sale plan is subsequently provided to the broker for review. Following a review, the broker forwards the sale plan to the corporate counselor. The counselor reviews the sale plan in view of issues relating to the issuer of the restricted stock. If the corporate counselor does not find any problems, the sale plan is sent back to the broker for possible acceptance. An authorized person within the broker then accepts the sale plan following a final review if no problems are found. Notifications are then sent to the holder informing the holder that the sale plan has been accepted. Individual sales of the restricted stock, called for by the sale plan, are automatically and periodically initiated as specified by the sale plan.

In a preferred embodiment, the present invention comprises a computer-implemented system for creating, modifying, and executing a restricted stock sale plan, comprising:

a plurality of processing stages, each processing stage comprising a plurality of parameters defining operational aspects of the processing stage, wherein the parameters comprise:

a first parameter that defines a set of entities authorized to act with respect to the restricted stock sale plan during the processing stage, the set of entities comprising one or more entities;

a second parameter that defines a set of actions that the set of entities is authorized to perform during the processing stage, the set of actions comprising one or more actions; and

a third parameter that defines a set of processing stages to which the restricted stock sale plan may be released at the discretion of a member of the set of entities, the set of processing stages comprising one or more processing stages.

In a preferred embodiment, the plurality of processing stages includes

a sale plan initiator stage in which

the set of entities comprises a sale plan initiator;

the set of actions comprises a creation of a sale plan contract and a set of sale plan parameters; and

the set of processing stages comprises an initial broker approval stage.

In a preferred embodiment, the plurality of processing stages includes

an initial broker approval stage in which

the set of entities comprises a broker;

the set of actions comprises a review of a sale plan contract and a set of sale plan parameters produced by a sale plan initiator stage; and

the set of processing stages comprises the sale plan initiator stage and a counselor approval stage.

In a preferred embodiment, the plurality of processing stages includes

a counselor approval stage in which

the set of entities comprises a counselor;

the set of actions comprises a review of a sale plan contract and a set of sale plan parameters forwarded from an initial broker approval stage; and

the set of processing stages comprises a sale plan initiator stage and a final broker approval stage.

In a preferred embodiment, the plurality of processing stages includes

a final broker approval stage in which

the set of entities comprises a broker;

the set of actions comprises a final review of a sale plan contract and a set of sale plan parameters forwarded from a counselor approval stage; and

the set of processing stages comprises a sale plan initiator stage.

In a preferred embodiment, the plurality of processing stages includes

a controller execution stage in which

the set of entities comprises a controller; and

the set of actions comprises initiation of a delegending process for each sale specified in a sale plan and a set of sale plan parameters, said sale plan and said set of sale plan parameters forwarded from a final broker approval stage.

### BRIEF DESCRIPTION OF THE DRAWINGS

FIG. 1 is a schematic diagram illustrating an overview of the present system;

FIG. 2 is a schematic diagram illustrating a server configured in accordance with a preferred embodiment of the present system;

FIG. 3 is a schematic diagram illustrating a user computer configured in accordance with a preferred embodiment of the present system;

FIGS. 4A-4D illustrate a process diagram describing actions of a single holder and events triggered by the actions of the holder in Stage I of Process I to delegend one or more restricted stocks.

FIGS. 5A-5B illustrate a process diagram depicting actions of the Brokerage Firm or a representative of the Holder and events triggered by these actions during Stage II of Process I to delegend restricted stocks.

FIGS. 6A-6C illustrate a process diagram of Stage III and Stage IV of Process I that depict actions of the Issuer of the restricted stocks and the Internal or Outside Counsel of the Issuer of the restricted stocks and the events triggered by these actions.

FIGS. 7A-7C illustrate a process diagram describing actions of the Transfer Agent of the Issuer and events triggered by these actions during Stage V of Process I directed to delegend restricted stocks.

FIGS. 8A-8D illustrate a process diagram describing actions of a venture capital fund representative and events triggered by these actions during Stage I of Process II directed to the distribution of restricted stock held by a fund of a General Partnership (Venture Capital Partnership, Private Equity Partnership etc.) (“VC fund”) to the partners of the VC fund.

FIGS. 9A-9C illustrate a process diagram describing actions of the Internal or Outside Counsel of the Issuer of the Stocks held by the venture capital fund and events triggered by these actions during Stage II of Process II directed to the distribution of restricted stock held by a VC fund to its partners.

FIGS. 10A-10C illustrate a process diagram describing actions of the Transfer Agent of the Issuer of the Stocks held by the VC fund and events triggered by these actions during Stage III of Process II directed to the distribution of restricted stock held by a VC fund to the partners of the VC fund.

FIG. 11 illustrates a process diagram describing actions of a holder and a broker and events triggered by these actions during a first stage of a process to create and execute a sale plan.

FIG. 12 illustrates a process diagram describing actions of a broker and events triggered by these actions during a second and fourth stage of a process to create and execute a sale plan.

FIG. 13 illustrates a process diagram describing actions of a corporate counselor and events triggered by these actions during a third stage of a process to create and execute a sale plan.

### DETAILED DESCRIPTION OF THE PREFERRED EMBODIMENT

The present invention includes an Internet-based, or other network-based, process for executing a 10b5-1 sale plan for restricted stocks. The invention creates a process by which the actions, approvals, and documents of the various entities involved in the process are recorded, monitored, generated and communicated. Additionally, as each stage of the process is completed, automated notifications are sent to various entities involved in the process.

In a preferred embodiment, the invention includes a Website and a database. The Website allows various entities involved in the process to receive notifications, select actions pending their intervention, perform their tasks, and generate automatic notifications to the entities that require notification. Various entities involved in the process can also use the Website to access their records and relevant portions of action records that are pending their intervention.

In one aspect of the invention records of the actions initiated by Holders or a Venture Capital Firm, Private Equity Partnership, or other such Limited Partnership Entity fund representative (“VC fund”) are created. At each stage of the process, a record of an action is updated to reflect progress. Documents are stored in the database and are updated automatically based on the actions. Automated notifications are sent to entities that approve the documents and generate their own documents or have already done so. The document forwarding, approval, and generation process is done via an Internet-based, or other network-based, process. A record of each action by the various entities is kept and the necessary notifications are sent via an automatic notification process.

The database contains records of the various entities that are involved in the process, including Holders, VC funds, Issuers, Legal Counsels, Transfer Agents, Brokerage Agents.

Each Holder has a record. Holders are individuals, corporations, trusts, or institutions. This record contains basic information of the Holder including the name, Tax-ID, contact information, authorized persons list and documentation regarding authorized persons.

In addition, the Holder record contains a sub-record for each of the individual holdings of restricted stock owned by the Holder. The sub-record contains information including the Issuer of the stock, stock certificate number, legend type, legend text, affiliate status of the Holder, date of acquisition, date of automatic legend restriction change or termination, manner of acquisition, and broker information if relevant. This record also contains links to the records of the Issuer and/or Broker as needed.

In addition, the Holder record contains a sub-record for each VC fund of which the Holder is a limited partner. This sub-record contains links to the records of each VC fund involved.

The database includes records for VC Firms. A VC Firm record contains the basic information of the VC Firm including the name, address, tax-id, contact information, authorized persons list & documentation with a sub-record for each VC fund of the VC Firm.

The VC fund sub-record contains information regarding the partners of the VC fund (with links to the Holder record of each limited partner), a breakdown of the interests of the partners, and information and documents regarding distribution mechanisms of the fund.

In addition, the VC fund sub-record contains a sub-record for each restricted stock held by the fund. This sub-record is similar to the sub-record of holdings in a Holder record as described earlier.

The database also contains records of the Issuers of restricted stock. The Issuer record contains basic information regarding the Issuer including name, address, contact information, authorized persons list & documentation, affiliates list (with links to the Holder record of each affiliate), Legal Counsel name (with links to the Legal Counsel record), and Transfer Agent names (with links to the Transfer Agent record). The record of the Issuer also contains procedures and documents for restricted stock actions, and other relevant information.

The database also contains records for the Legal Counsel that serve the Issuers. The Legal Counsel record contains basic information such as name, address, and tax-id. This record also contains a sub-record for every Issuer that the Firm serves as Legal Counsel (with links to the Issuer record and the record of the Transfer Agent of the Issuer) containing the authorized persons list for acting for the specific Issuer. Further, the record also contains procedures, documents, and opinions about the tasks performed by the Legal Counsel.

The database contains records for Transfer Agents of Issuers. The Transfer Agent record contains basic information such as name, address, tax-id, authorized persons list & documentation, information regarding physical delivery, and Deposit Trust Corporation delivery information. This record also contains a sub-record for each Issuer served by the Transfer Agent (with links to the Issuer record and respective Legal Counsel record). This sub-record also contains a list of authorized persons at the Transfer Agent working with the Issuer and procedures and documentation for tasks performed by the Transfer Agent.

The database also contains records for Brokers that work with Holders. These records contain basic information about the respective entities and sub-records for each Holder account.

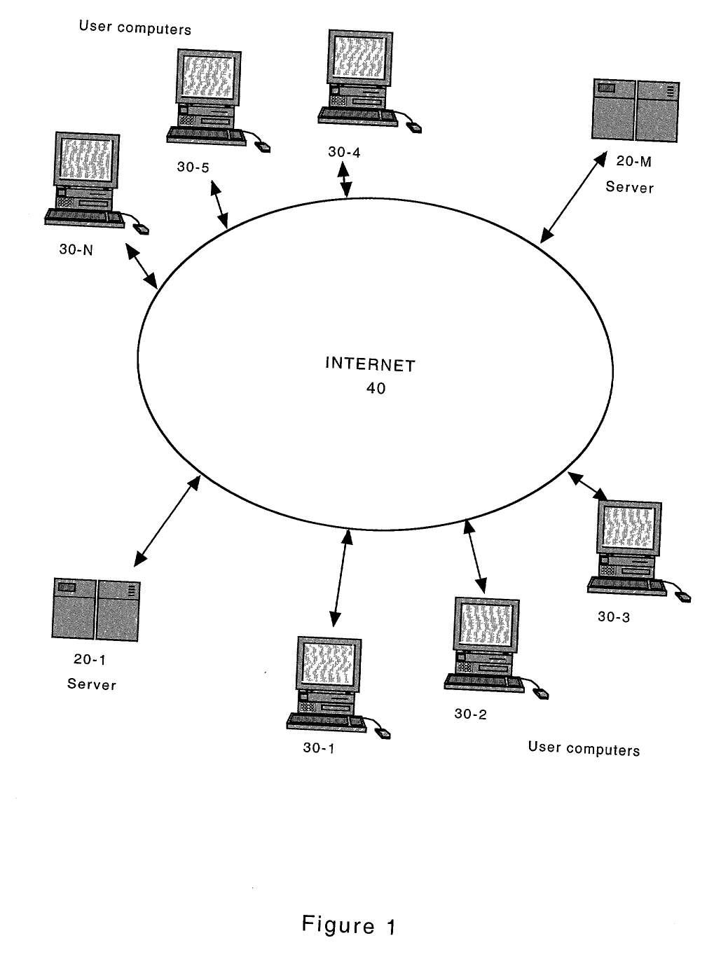

Reference is now made to FIG. 1, which is a schematic diagram illustrating an overview of the system of the present invention. Server 20 is connected to user customer 20 via a communications network, such as Internet 40.

Not included in FIG. 1, but likely included in a preferred embodiment of the invention are routers, load balancing switches, fire walls, and switches. Persons skilled in the art will recognize that these elements are often included in systems designed to interface with users via Internet 40. These elements provide requisite levels of security and robustness required by the present invention. Also not included in FIG. 1 were the many means of accessing Internet 40 from user computer 30. For example, user computer 30 can reside behind a corporate firewall on a local area network. In that case, the local area network is possibly connected to an Internet Service Provider via dedicated T1 line. Additionally, user computer 30 can also connect to Internet 40 directly through an Internet Service Provider through a dial-up connection or cable modem.

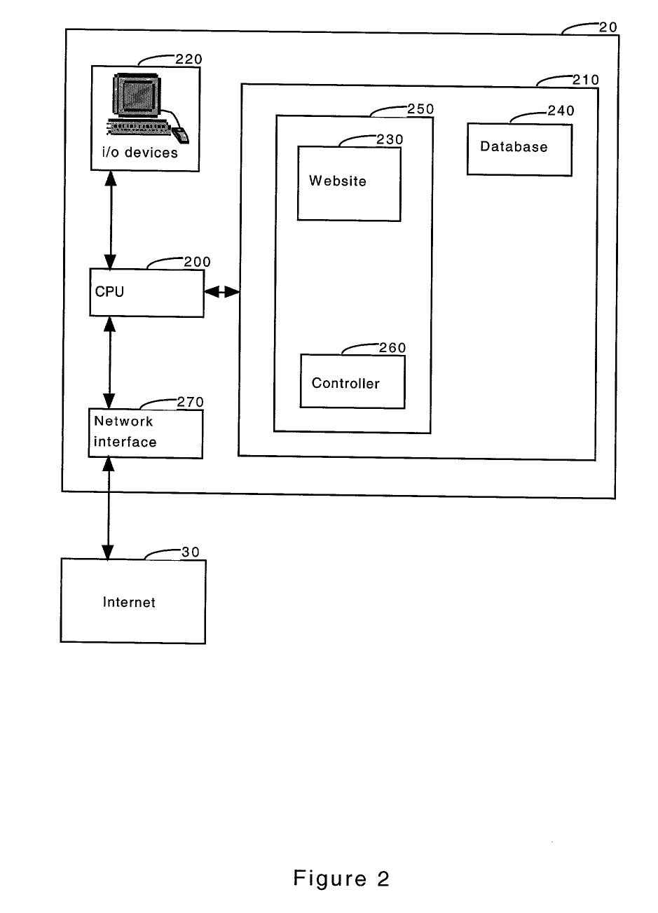

FIG. 2 includes a schematic diagram illustrating server 20 configured in accordance with a preferred embodiment of the present invention. Server 20, is preferably a programmed general purpose computer that includes processor 200, memory 210, i/o devices 220, and Website 230 that is accessible via Internet 40. As shown, memory 210 preferably includes database 240, and computer programs 250 for operating server 20 in accordance with an embodiment of the invention. In particular, controller 260 operates server 20 generally and performs the operations unique to the present invention. For example, controller 260 processes commands received from user computer 30 through Website 230, and if necessary, writes to or reads from database 240, in accordance with the present invention. Server 20 also includes network interface 270, which provides access to Internet 40. As is well known in the art, database 240 can be located apart from server 20 and connected thereto by a communications network. For example, database 240 can be maintained on multiple database servers. Additionally, Website 230 can reside on a dedicated web server. Finally, as indicated in FIG. 1 multiple servers 10 are available to interact with user computer 10 in case the primary server 20 fails.

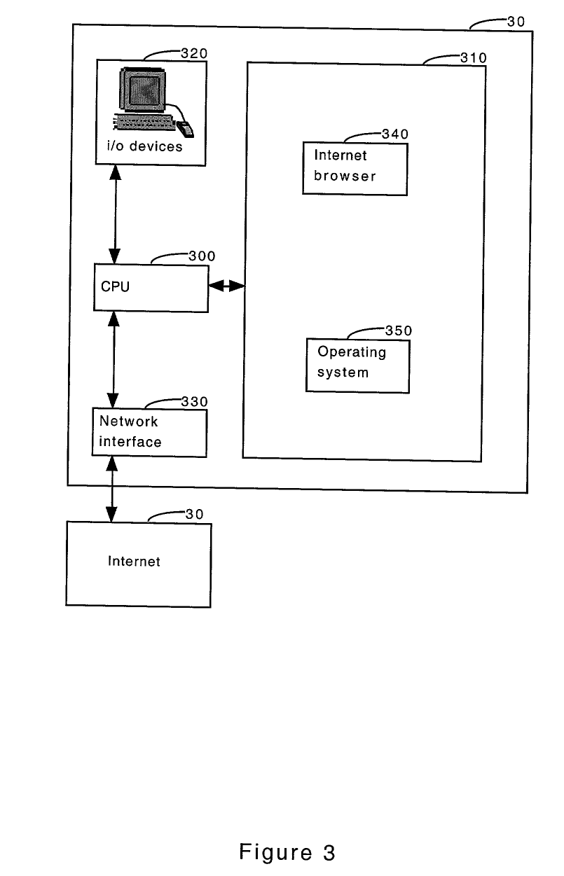

FIG. 3 includes a schematic diagram illustrating user computer 30 configured in accordance with a preferred embodiment of the present system. User computer 20 is also preferably a programmed general purpose computer that includes processor 300, memory 310, and i/o devices 320 such as a monitor, mouse, and keyboard. User computer 20 also preferably has access to the Internet 40 through network interface 330. As shown, memory 310 preferably includes Internet browser 340 and operating system 350, which controls the general functionality of user computer 30. User computer 20 may take many forms. Exemplary forms include personal computers, personal digital assistants, Internet accessible office automation devices, Internet accessible home appliances, televisions, and digital telephones. Other forms that now exist, or are possible, are within the scope of this invention.

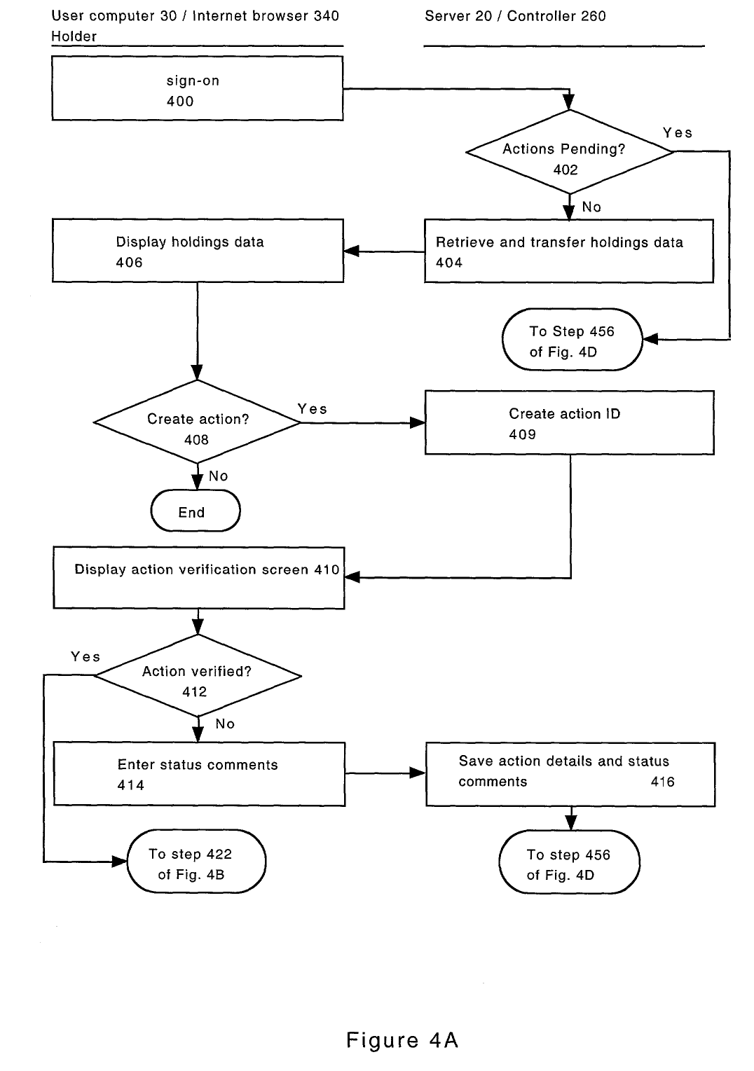

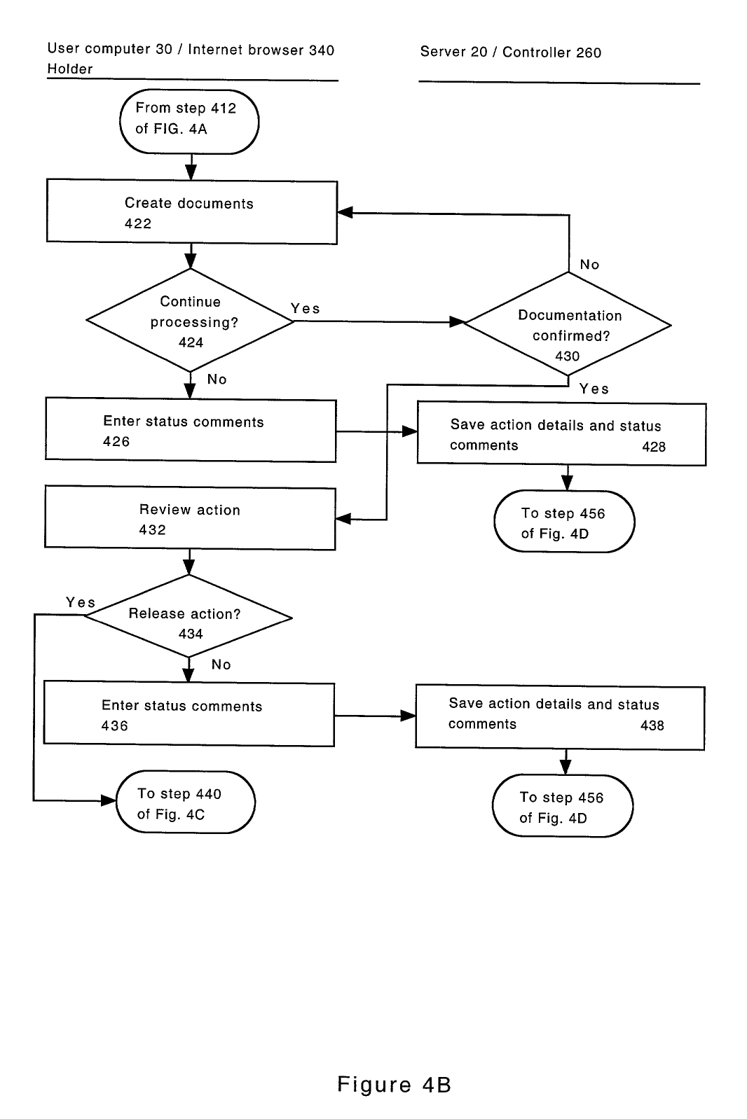

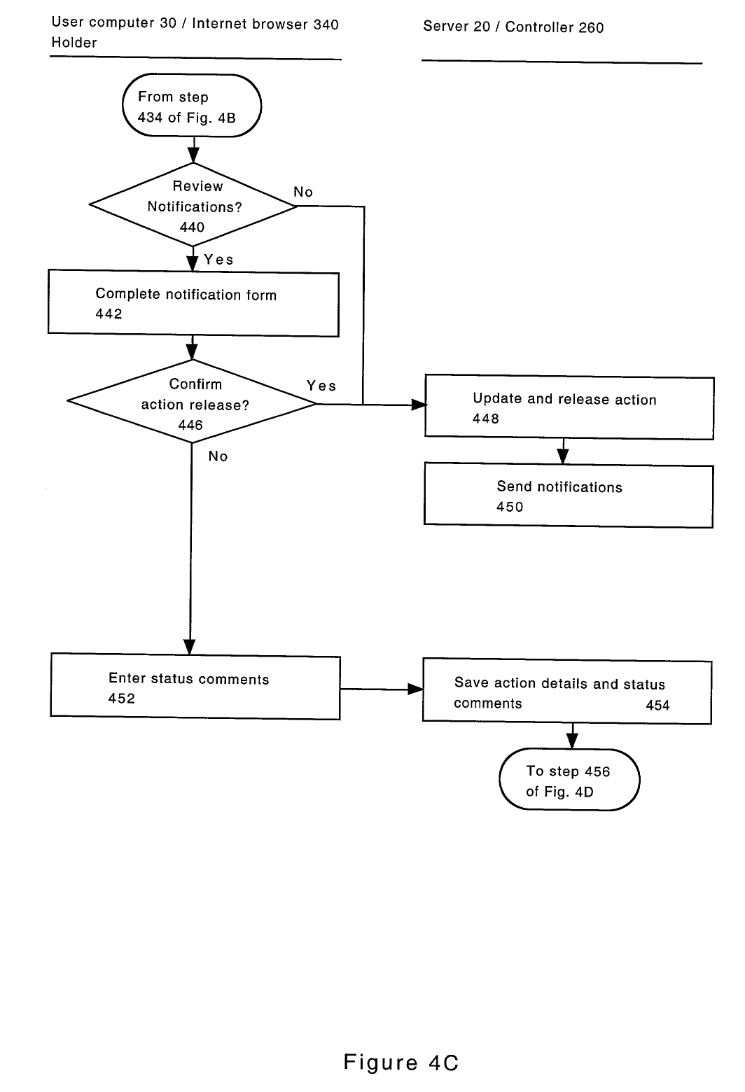

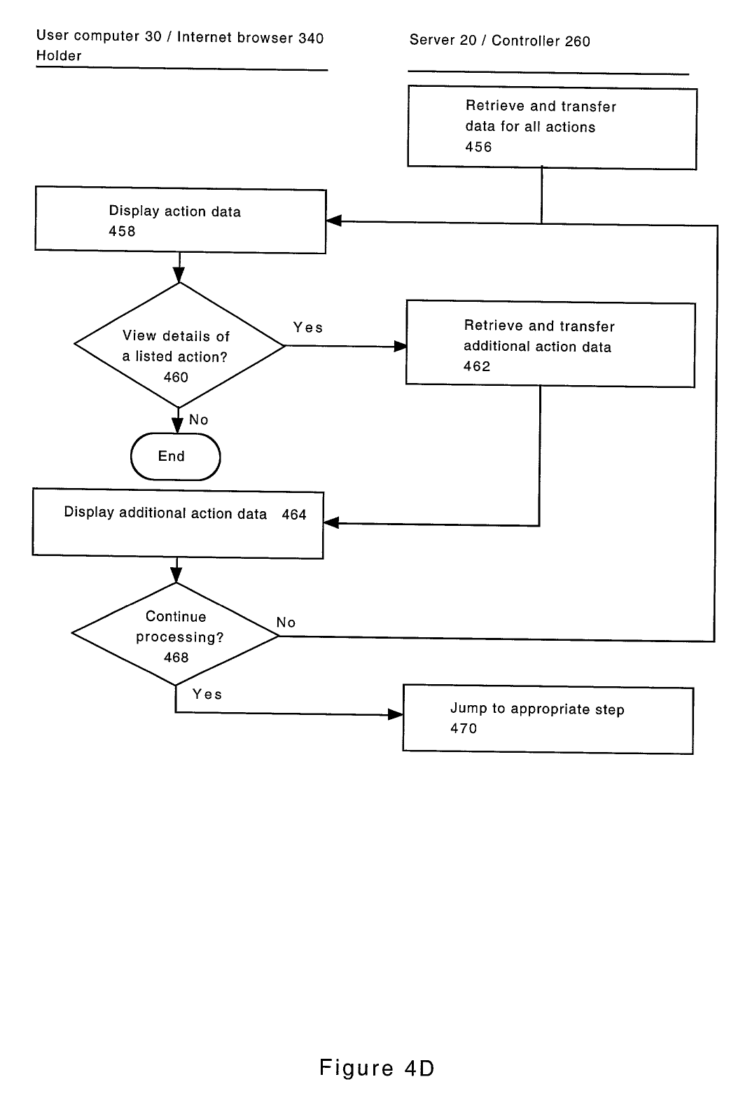

FIGS. 4A-4D illustrate a process diagram of Stage I of Process I, which describes the actions of the Holder and the events triggered by the actions of the Holder. The Holder signs onto Server 20 of an embodiment of the invention and selects the specific stock certificates that the Holder wishes to process. Upon this action by the Holder, an embodiment of the invention retrieves the necessary documents from database 240. The data from the Issuer and the stock certificates selected by the Holder are merged into these documents. These documents are displayed to the Holder. The Holder executes these documents on or off-line. The Holder has the option of selecting a broker. The Holder then releases the action to the next stage of the process. The documents executed by the Holder are stored in database 240 and optionally printed. Automatic notifications (with the relevant detail including the action-ID) are sent to the entities pre-specified in the process. These entities include the Issuer, the Legal Counsel of the Issuer, and a Brokerage Firm if selected by the Holder. The notifications are delivered via email, fax, beeper, or Internet generated phone call. The mode of notification is preselected and stored in database 240. Preferably, these decisions are made when an account is created for a Holder. Similar steps are preferably taken for the other entities as well.

As an option, the process will allow automated, on-line filing of forms, such as Form 144, with the Securities and Exchange Commission as the SEC establishes a policy to accept such electronic filing. As an option selected by the Issuer, the actions of the Holder may be used to update the Form 4 of the Issuer.

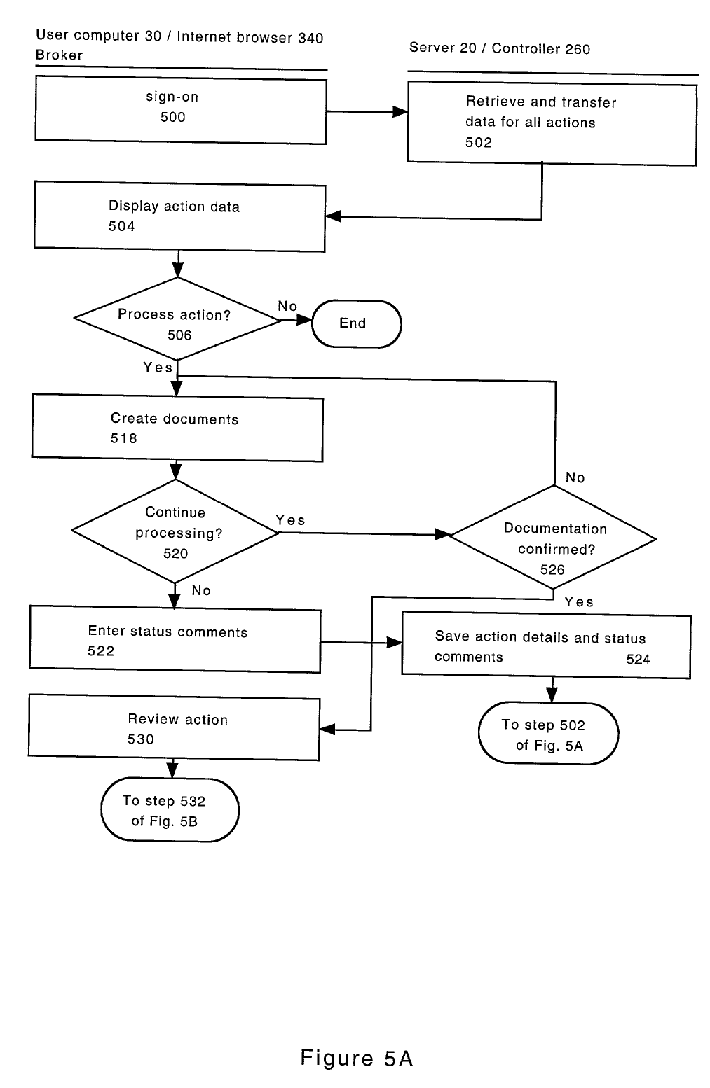

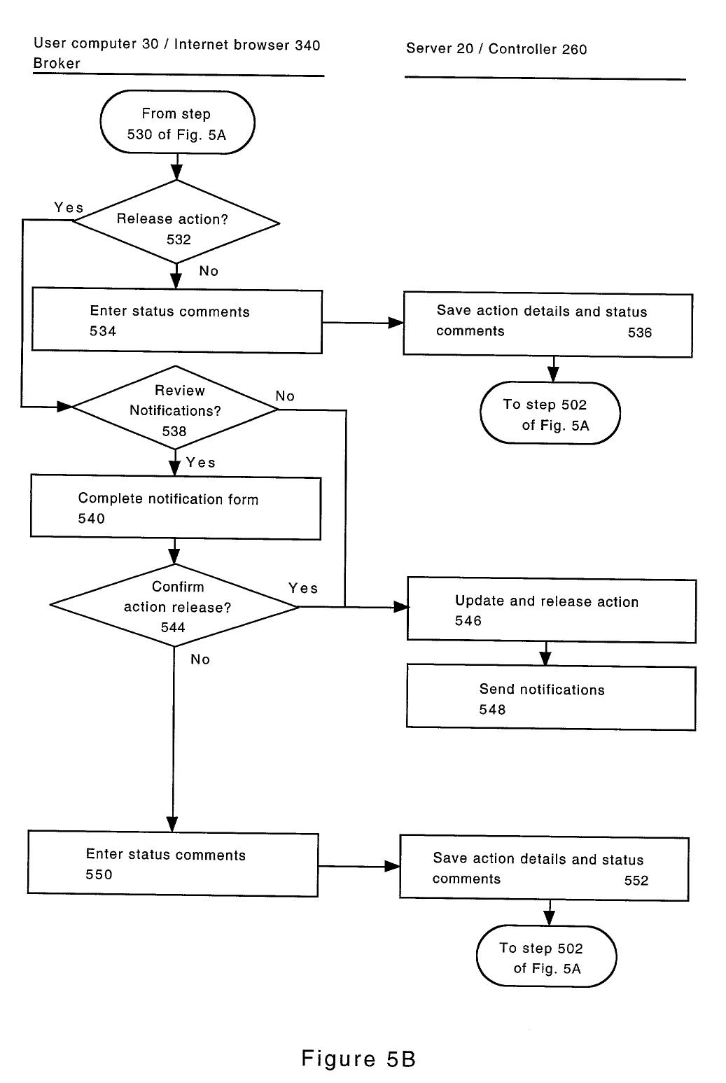

FIGS. 5A-5B illustrate a process diagram of Stage II of Process I that describes the actions taken by a Broker employed by the Holder, a representative of the Holder, or the Holder and the events triggered by these actions. Recall that in Stage I, the Holder has the option of selecting a Broker. If a Broker is selected, the Broker completes this stage. Otherwise, the Holder works manually with the Broker and the Holder or the Holder's representatives execute this stage. However, for the sake of simplicity, this step is described with reference to a Broker. The Broker signs onto Server 20 and enters the records of the stock certificate sale if a sale has taken place. This would include the trade date and the sale price. At the option of the Holder, an automated notification is sent to the tax counsel of the Holder. If the Broker is the entity executing this step, the documents necessary for execution by the Broker are displayed to, and executed by, the Broker. These executed documents are stored in database 240 and optionally printed. Automated notifications are sent to all entities notified at the completion of Stage I. The action is released to Stage III.

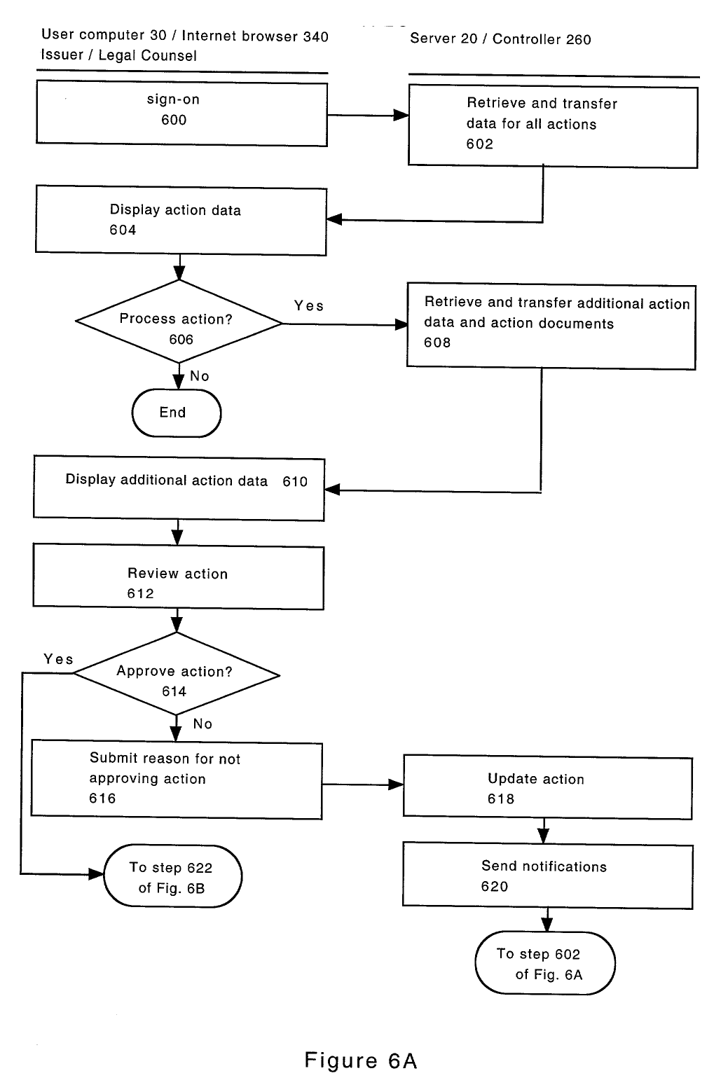

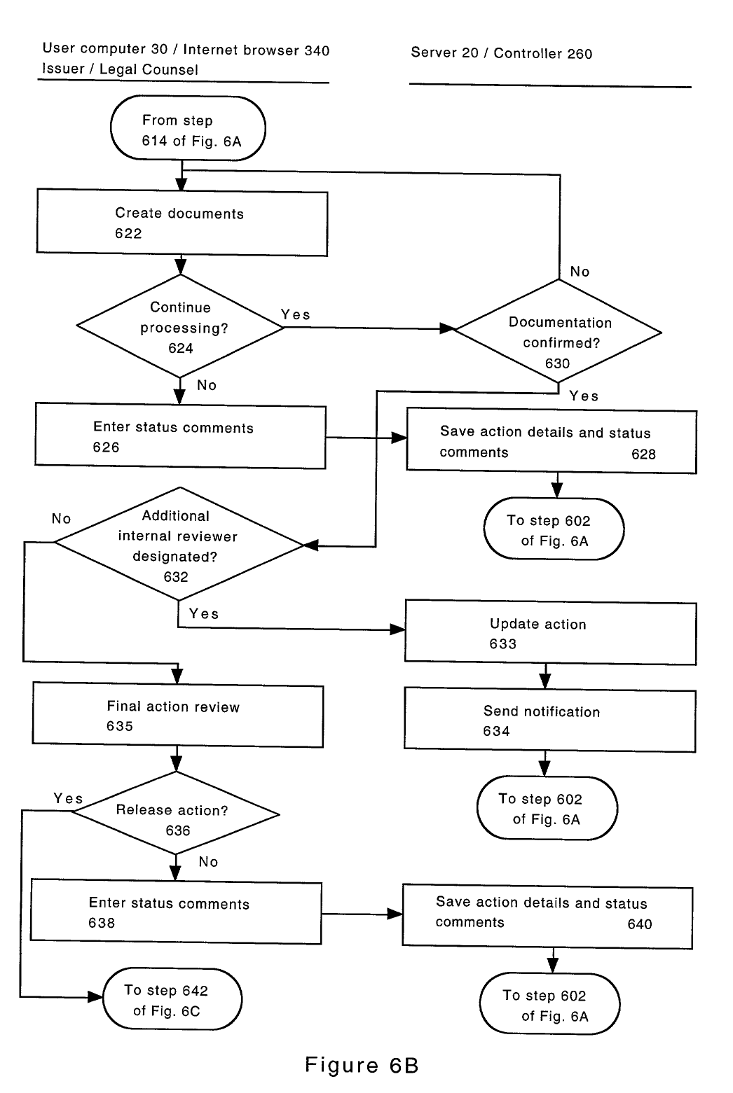

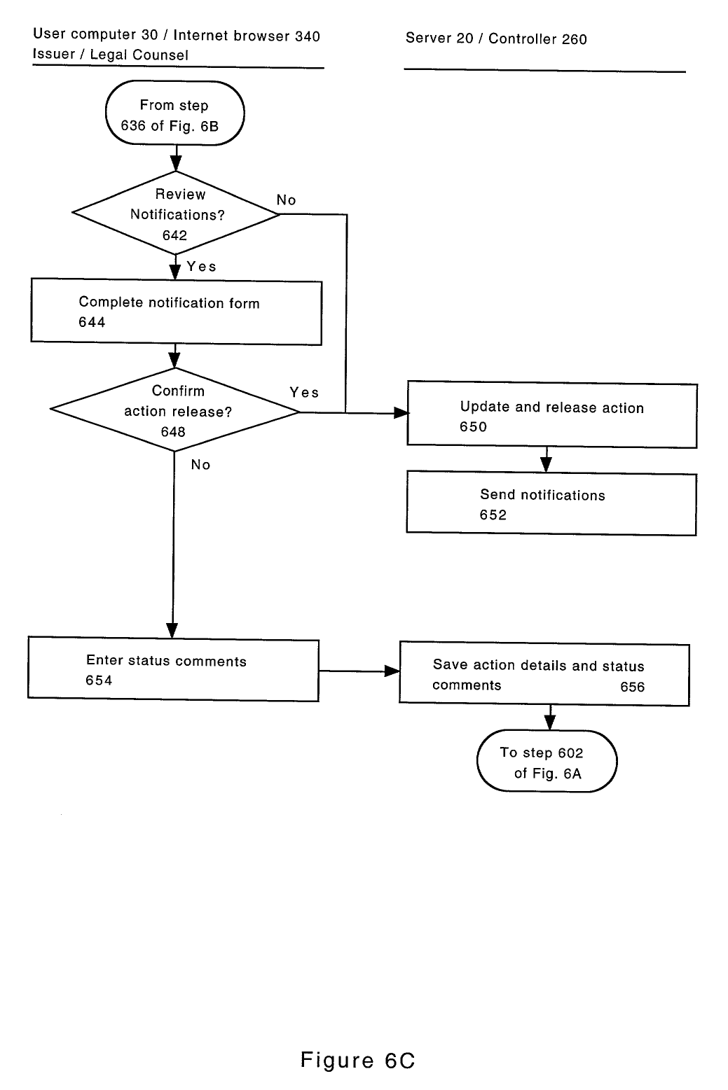

FIGS. 6A-6C illustrate a process diagram of Stage III of Process I, which describes the actions of the Issuer of the stock that the Holder has selected to delegend and the events triggered by these actions. The Issuer is notified of the actions taken by the Holder in Stage I and the Broker in Stage II as described above. The Issuer signs onto Server 20. The Issuer selects a specific action preferably by selecting an action from a menu of all actions pending intervention by the Issuer. The Issuer then reviews the documents created by the Holder and the Broker. Next, the Issuer has the option of approving or disapproving each action. If the action is disapproved, the action is suspended and automatic notifications are sent to the Holder, Broker, and other relevant entities. If the action is approved, the Issuer then creates any needed documentation. Once processing is completed by the Issuer Automatic notifications are sent to the Legal Counsel, Holder and other entities notified at the completion of Stage II. The action is released to Stage IV.

FIGS. 6A-6C also illustrate a process diagram of Stage IV of Process I, which describes the actions taken by Legal Counsel of the Issuer and the events triggered by these actions. The Legal Counsel signs on to Server 20 and selects an action. As in Stage II and Stage III, the action is preferably selected from a menu of actions pending intervention by the Legal Counsel. The Legal Counsel approves or disapproves the action. If the Legal Counsel disapproves the action, the action is suspended with the appropriate suspension code or reason and automatic notifications are sent to all entities notified at the completion of Stage III. If the action is approved, the relevant documents are retrieved from database 240 and updated with the details about the specific action that is being approved. The resulting documents are then displayed. The Legal Counsel executes these documents, which are then stored in database 240 and optionally printed if executed on-line. Automatic notifications are sent to the Transfer Agent and all the other entities notified at the completion of Stage III. The action is released to stage V.

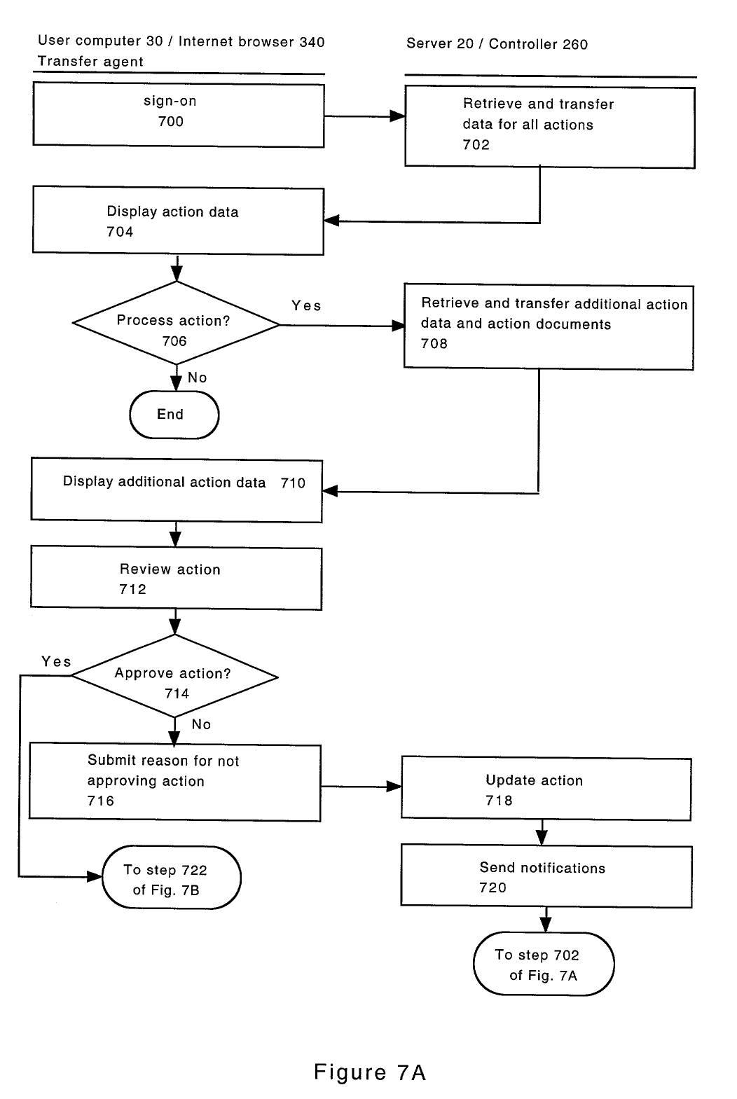

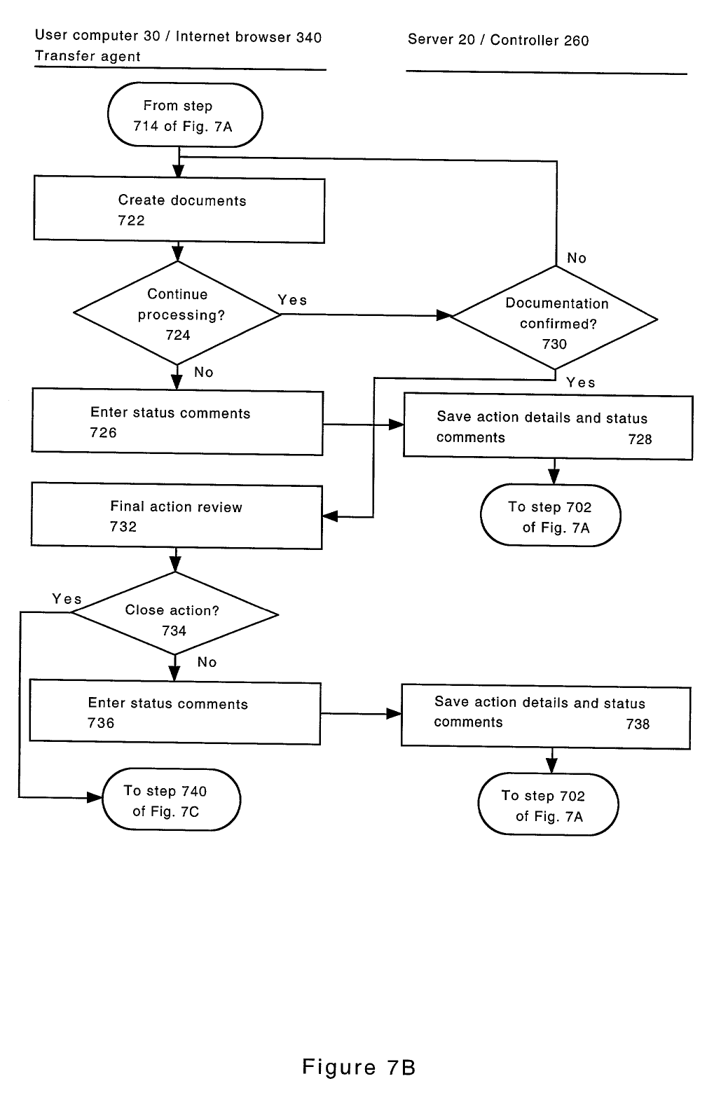

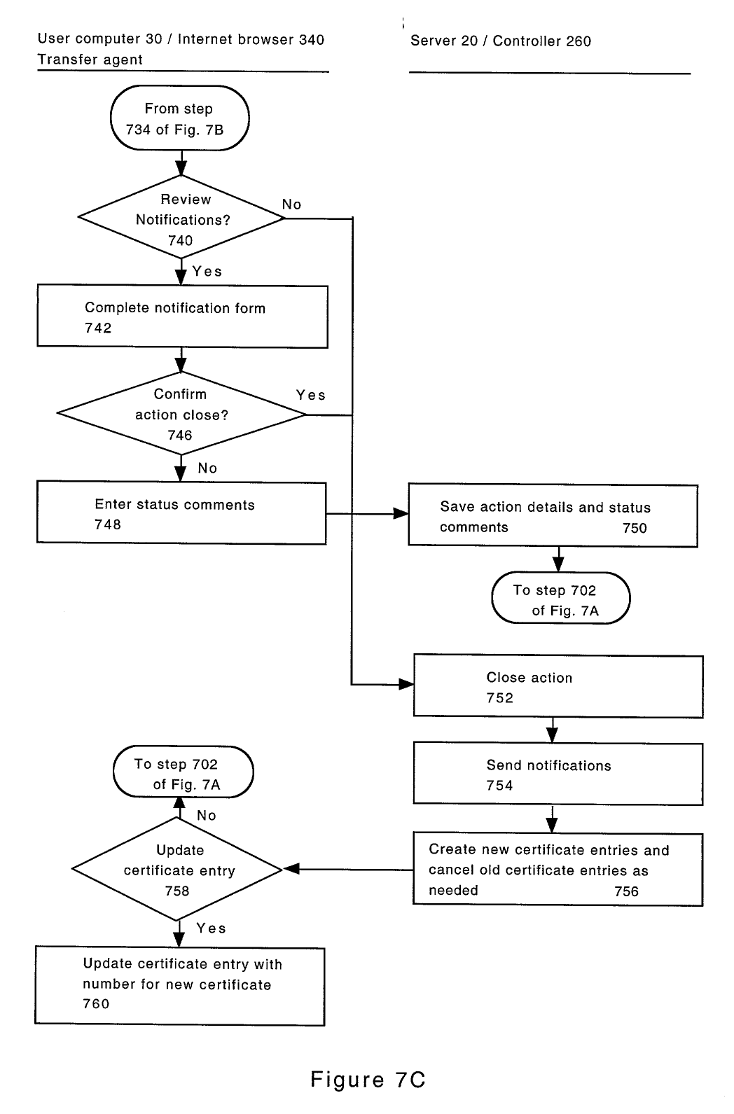

FIGS. 7A-7C illustrate a process diagram of stage V of Process I, which describes the actions taken by a Transfer Agent of the Issuer and the events triggered by these actions including the successful completion of Process I. The Transfer Agent signs onto Server 20 and selects an action. As in earlier stages, the action is preferably selected from a menu of actions pending intervention by the Transfer Agent. The Transfer Agent suspends or closes the action. If the action is suspended, the specific requirements needed to accept the action, as submitted by the Transfer Agent, are stored in database 240 and automatic notifications are sent to all the entities notified at the completion of Stage IV. If the action is accepted, the Transfer Agent specifies the details of the steps performed by the Transfer Agent including updates of the stock certificate records and the Holder records. Automatic notifications are sent to all the entities notified at the completion of Stage IV. The action is now successfully completed and closed.

Process II is a diagrammatic depiction of the steps involved in the distribution of restricted stock by VC funds to their partners.

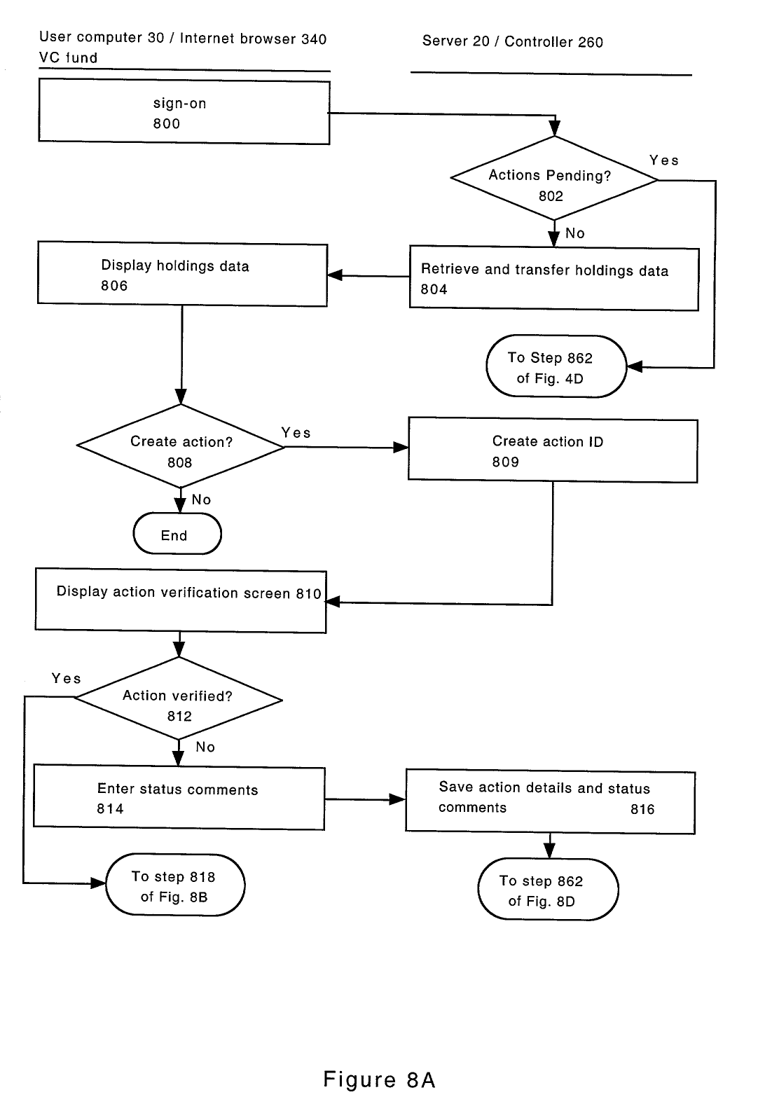

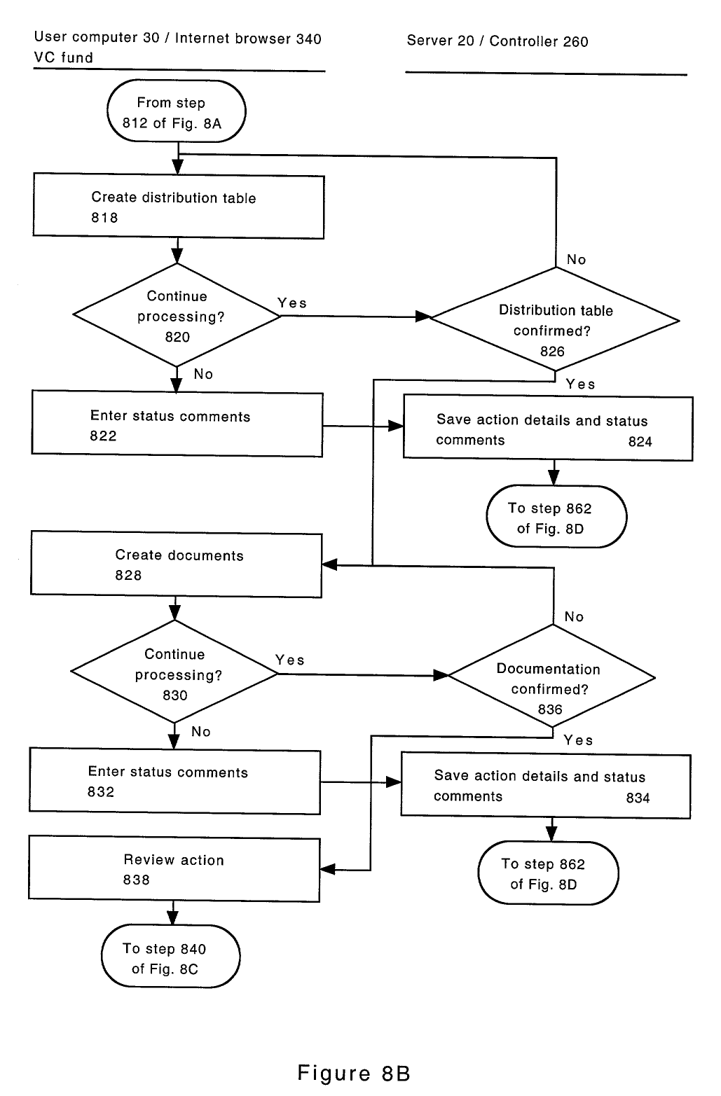

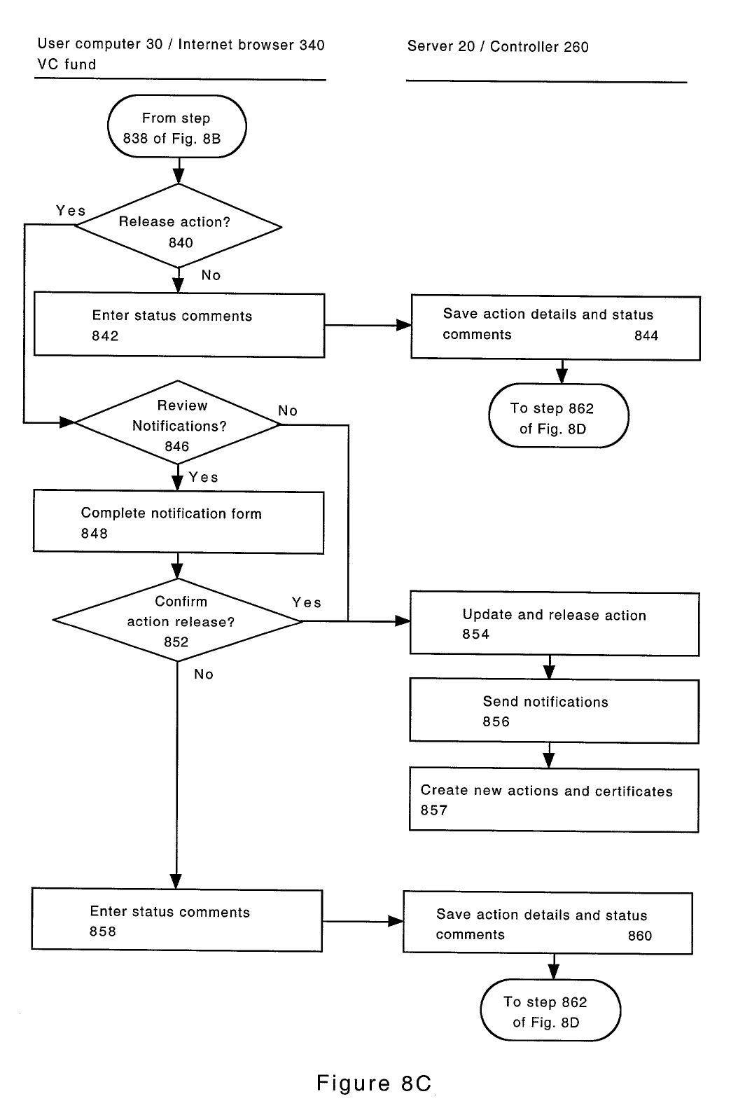

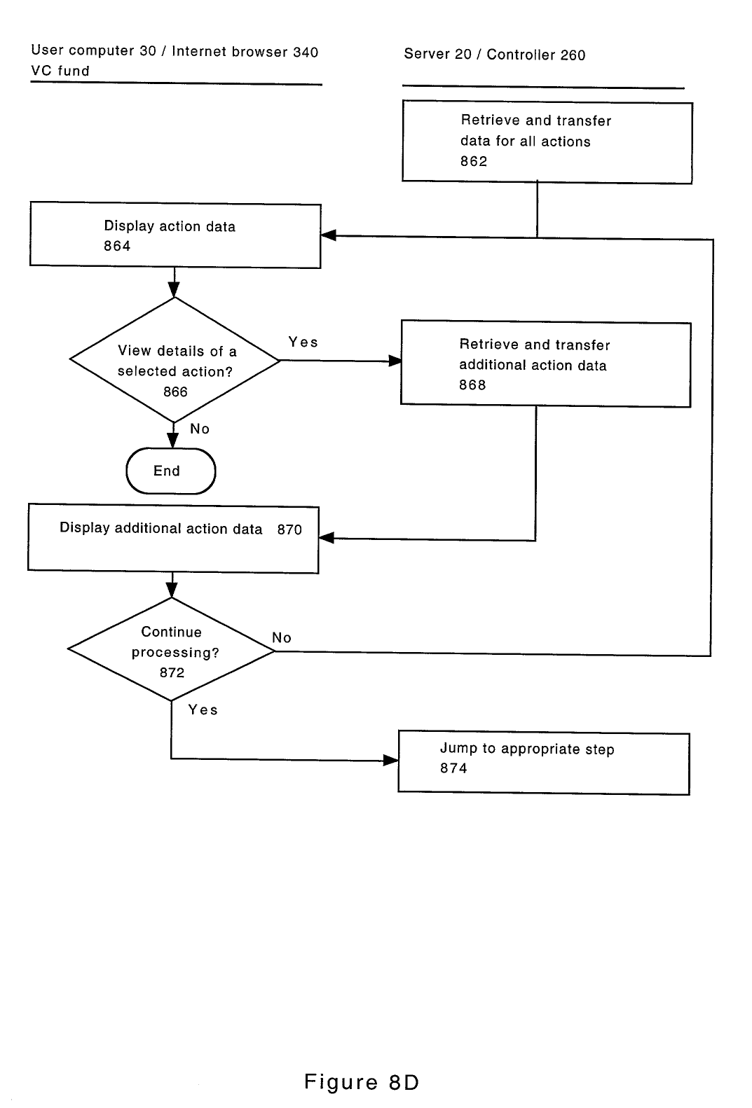

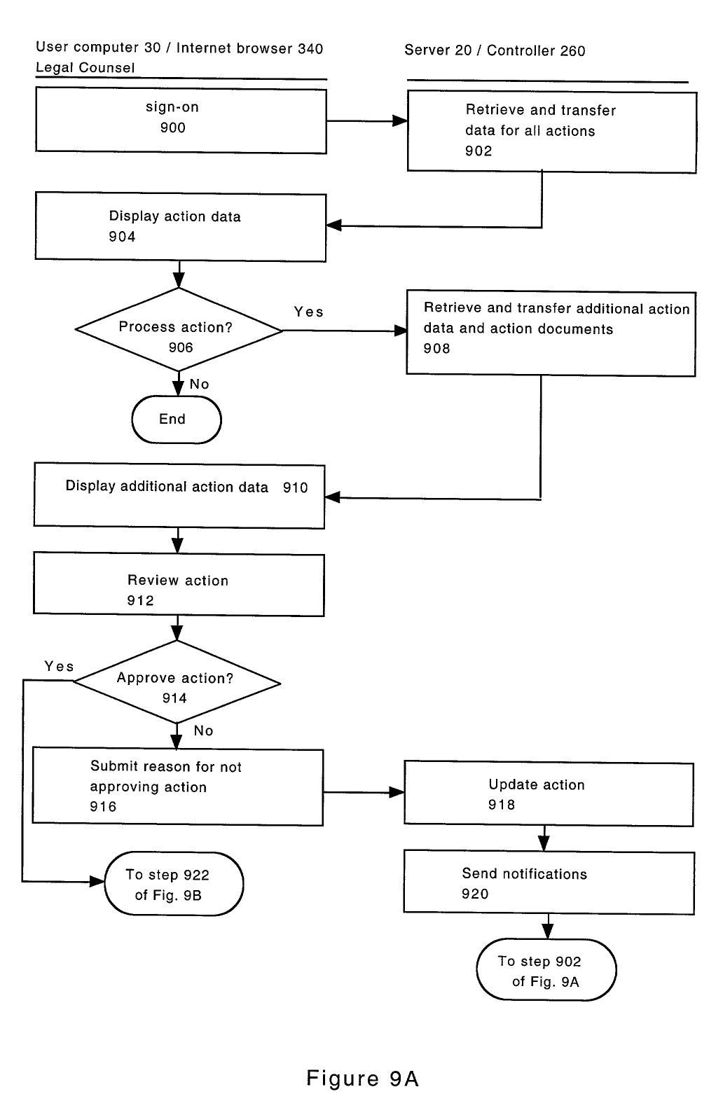

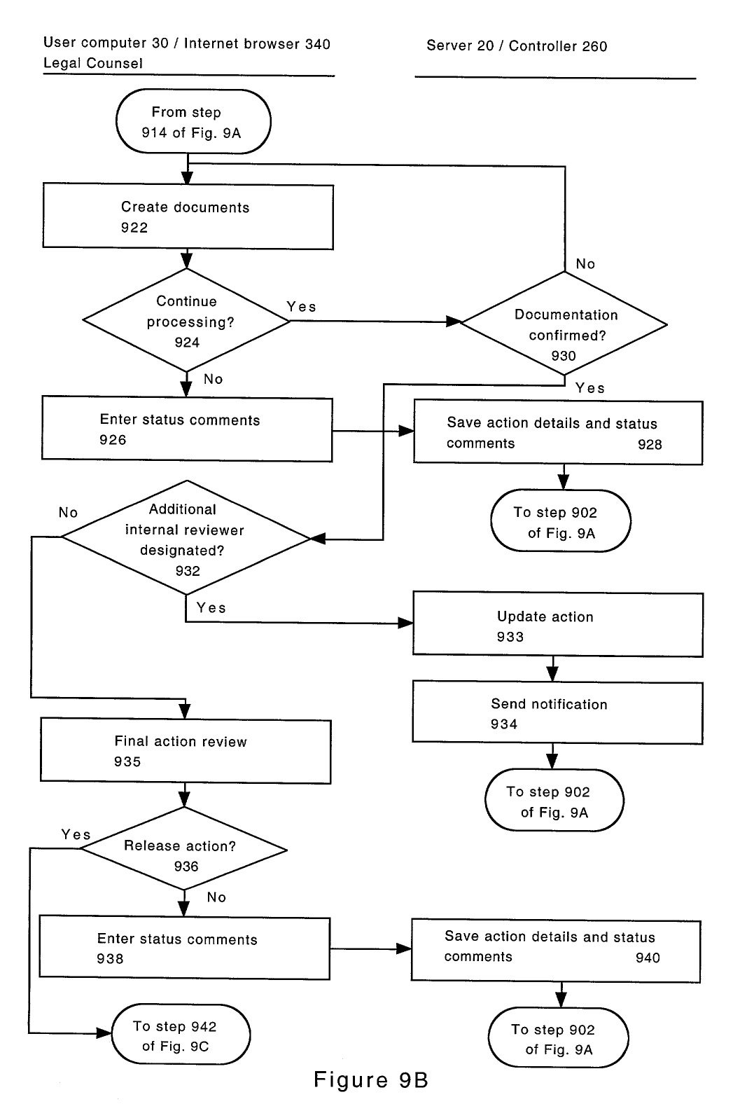

FIGS. 8A-8D illustrate a process diagram of Stage I of Process II, which describes the actions taken by a VC fund and the events triggered by these actions. On the date of the distribution, the VC fund selects the Issuer, the specific stock certificates and selects the action. Preferably, the documents necessary to facilitate the distribution action are created by the VC fund and stored in database 240 prior to initiating Stage I of Process II. Preferably, these documents are created when an account is created for the VC Firm. These may be from existing templates or forms prepared by the VC fund. These documents are retrieved and the details of the stock certificates selected by the VC fund are used to update the documents. The updated documents are then displayed. The VC fund then executes these documents. A distribution action is now created. A new sub-record is created in database 240 for each of the partners of the VC fund and this sub-record is updated with the details of the distribution that are relevant to each limited partner. These details include the name and number of the stock, the legend information, the delegending steps, the relevant documents and other information that the VC fund may specify. A pending action record is created for intervention by each limited partner. Automated notifications are sent to the Legal Counsel of the Issuer, the Transfer Agent of the Issuer, all partners of the VC fund and to the Broker that may have been optionally selected by the VC fund. Distribution documents are optionally printed as well. The distribution action is released to Stage II.

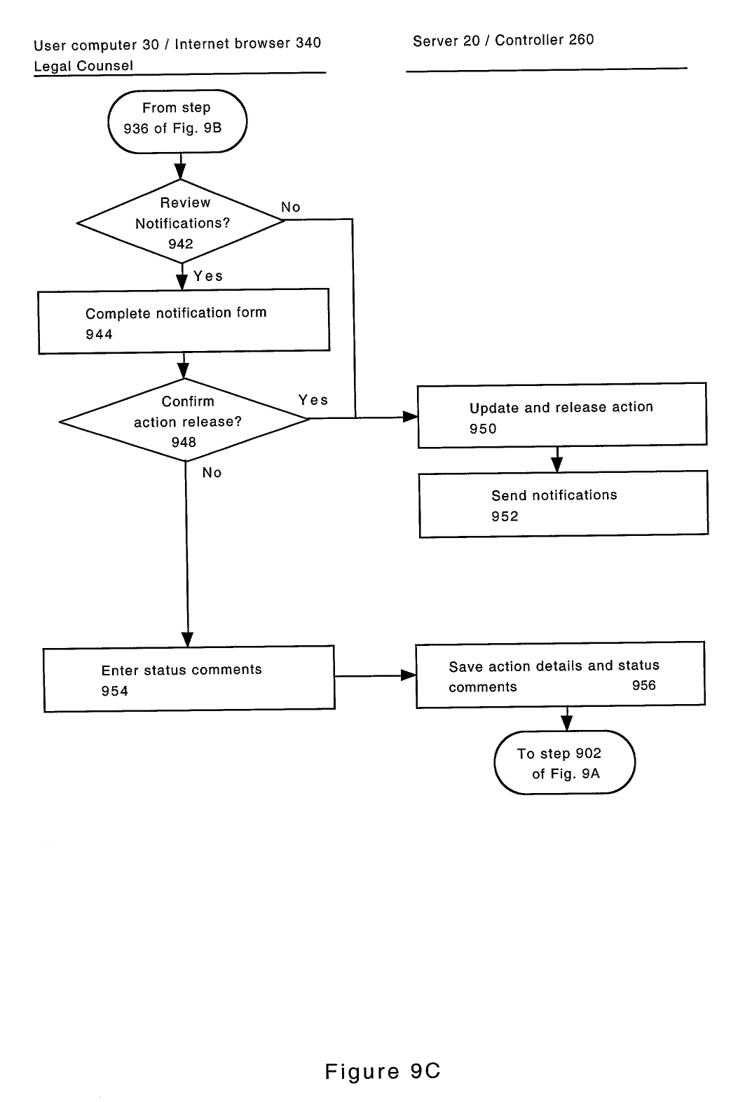

FIGS. 9A-9C illustrate a process diagram of Stage II of Process II, which describes the actions taken by the Legal Counsel of the Issuer of the stock distributed by the VC fund and the events triggered by these actions. The Legal Counsel of the Issuer signs onto Server 20 and selects the action from a menu of actions pending intervention by the Legal Counsel. The Legal Counsel views the distribution documents and either approves or disapproves the action. If the action is disapproved, the distribution action is suspended with an appropriate reason and the requirements for approval stored in database 240. Automatic notifications are sent to all entities notified at the completion of Stage I. If the action is approved, then the relevant documents are retrieved from database 240, updated with the details relevant to the specific distribution action that is being approved. The resulting documents are then displayed. The Legal Counsel executes these documents. The documents executed by the Legal Counsel are then stored in database 240 and optionally printed if executed on-line. Automatic notifications are sent to the Transfer Agent and all the other entities notified at the completion of Stage I. The action is released to Stage III.

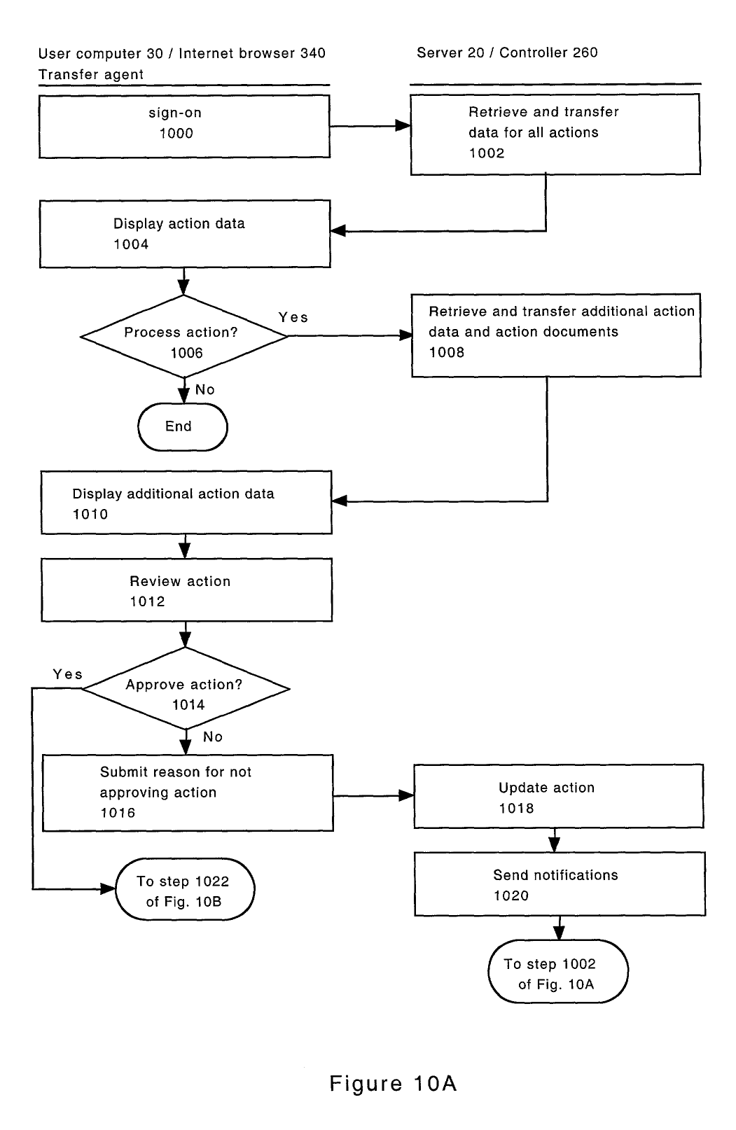

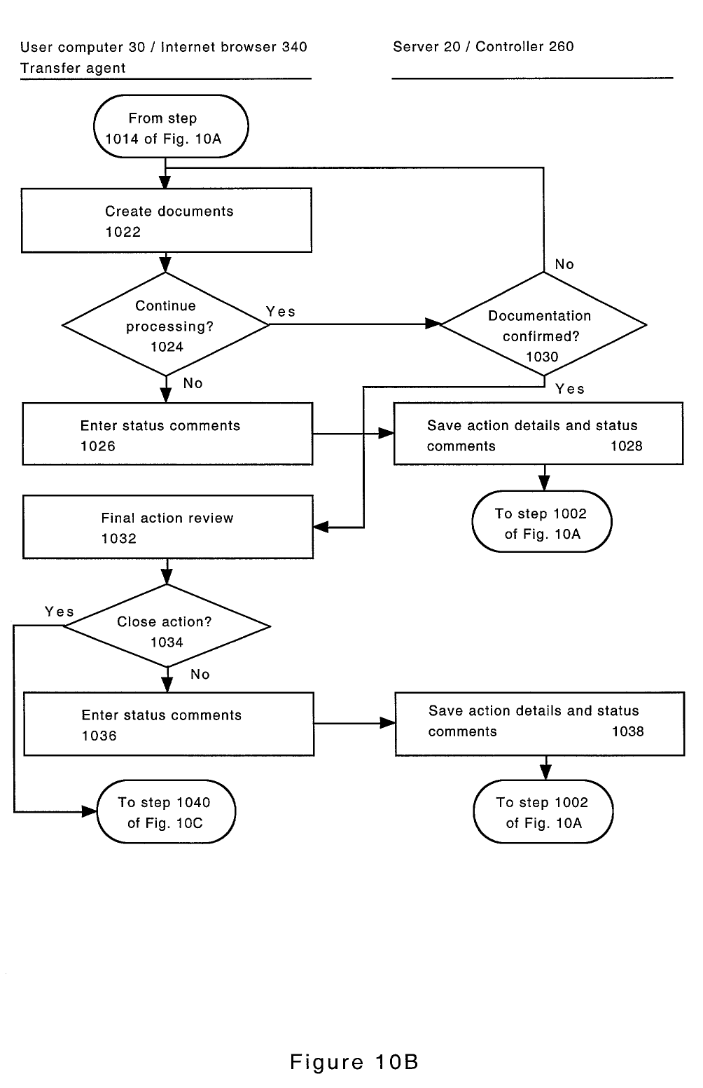

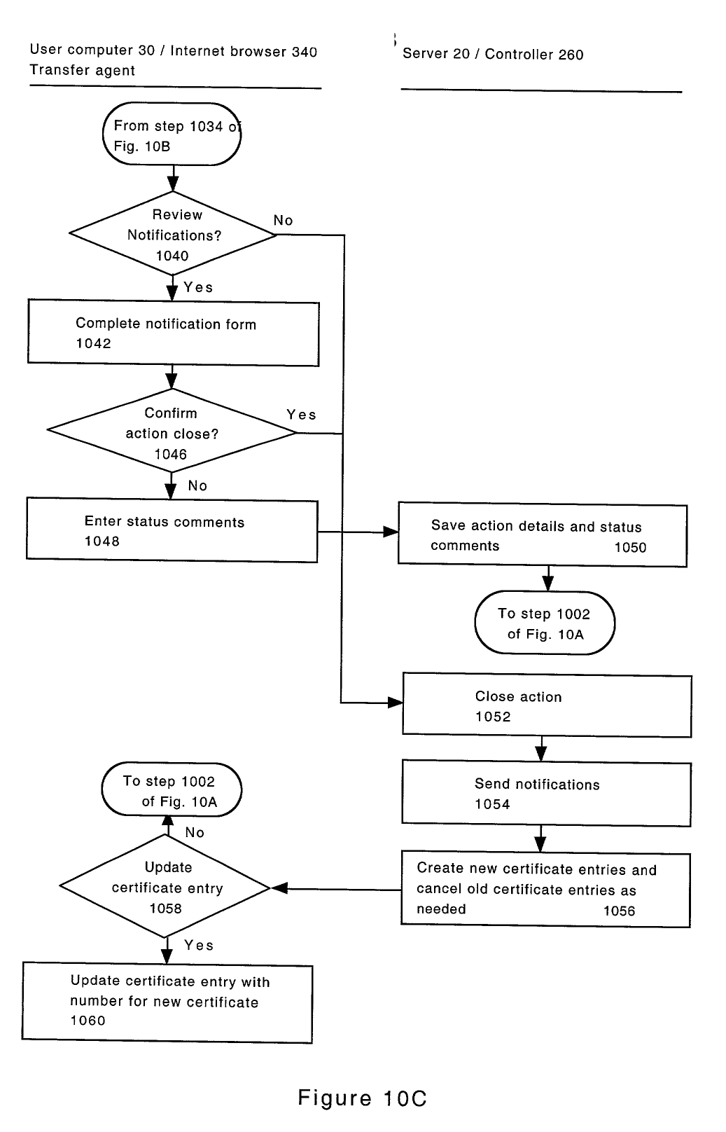

FIGS. 10A-10C illustrate a process diagram of Stage III of Process II, which describes the actions taken by a Transfer Agent of the Issuer and the events triggered by these actions including the successful completion of Process II. The Transfer Agent signs onto Server 20 and selects an action from a menu of actions pending intervention by the Transfer Agent. The Transfer Agent can suspend or close the action. If the action is suspended, then the specific requirements that would be needed to accept the action are stated by the Transfer Agent and automatic notifications are sent to the VC fund and the Legal Counsel and all other entities notified at the completion of Stage III. If the action is closed, the Transfer Agent specifies the details of the steps performed by the Transfer Agent. These details may include stock certificate numbers and data concerning new stock certificates created in the name of each limited partner. The holdings records and the pending action records of the partners are updated. Automatic notifications are sent to all the entities notified at the completion of Stage II. The action is now successfully completed and closed.

The general nature of the present invention has now been disclosed. Attention now turns to a more detailed discussion of the processing steps, found in a preferred embodiment of the present invention.

In particular, FIG. 4A illustrates processing steps executed when a Holder signs on to server 20 through the use of user computer 30 to initiate, continue, complete, or suspend Stage I of Process I. Upon accessing Website 230 using Internet browser 340 (e.g., Microsoft Internet Explorer, Netscape Navigator), a Holder signs on to server 20 using a user name and password combination (step 400). After the sign-on is completed, controller 260 determines if the Holder has any pending actions (e.g., a pending action to delegend one or more stock certificates) by reference to action records maintained in database 240 as described above (step 402). If so, processing step 456 of FIG. 4D, as described below, is executed. If not, controller 260 retrieves and transfers holdings data of the Holder from database 240 to user computer 30 (step 404). In particular, controller 260 accesses database 240 to locate each Holder sub-record for each of the individual holdings of restricted stock owned by the Holder. Persons skilled in the art will recognize that any number of techniques are capable of performing a keyword search against one or more databases.

This information is then displayed by Internet browser 360 on i/o device 320 (step 406). The holdings data displayed is preferably grouped by each stock certificate held by the Holder. Additionally, the displayed holdings data preferably includes the Issuer of the stock certificate, the fund to which the stock certificate belongs, the stock certificate number, the acquisition date of the stock certificate, the number of shares issued, the number of remaining shares (the number of shares issued minus the number of shares already processed), and the process type (e.g., Rule 144, Rule 701, Rule 144K).

The Holder then has the option of creating an action. The actions available to the Holder are the delegending and sale of, or just the delegending of, a specified number of shares from one or more restricted stock certificates. If the Holder opts to delegend and sell a specified number of shares from one or more restricted stock certificates, a Broker or other Holder representative is generally involved in the process. If the Holder opts only to delegend a specified number of shares from one or more restricted stock certificates, a Broker is typically not involved in the process.

As already indicated, the Holder can opt to create an action involving some or all of the shares from one or more stock certificates (in which case, the entry for the stock certificate with only a portion of the shares selected is adjusted accordingly to reflect a reduced number of shares remaining). However, the Holder cannot, in a single action, include stock certificates of different process types nor stock certificates issued by different Issuers. In other words, all stock certificates involved in a single action have unity of process type and Issuer.

If the Holder does not create an action (step 408-No), the Holder eventually signs off of server 20.

If however, the Holder creates an action (step 408-Yes), an action-ID is generated by controller 260 (step 409) and action verification data is displayed to the Holder (step 410). The action-ID is a unique identifier used to reference the newly created action throughout the various stages involved action. The displayed information preferably includes the selected action, the Issuer of each stock certificate selected, the stock certificate number of each stock certificate selected, and the total number of shares remaining for each stock certificate selected. The action-ID created by controller 260 is preferably displayed as well. Furthermore, the Holder is presented with a standard text box for entry of the number of shares to be acted upon for each stock certificate selected. The displayed information also preferably includes additional information for the purpose of avoiding errors or delays in the processing of the action. For example, the displayed information includes a reminder about the regulatory and legal responsibilities imposed on the Holder during this process.

Upon entering the desired number of shares and reviewing the displayed information, the Holder has the option to continue processing the action (i.e., verifying the action) or suspending and saving the action (step 412).

If the Holder suspends and saves the action (step 412-No), the Holder is prompted to enter status comments regarding the action (step 414). Status comments can include for example, the reason suspending and saving the action or instructions for later continuance of action processing. Controller 260 then saves the action details (the selected action, the Issuer of each stock certificate selected, the stock certificate number of each stock certificate selected, and the total number of shares selected from each selected stock certificate) and status comments in database 240 (step 416). Or more specifically, in an action record as described above. Action status data, as described below (beginning with reference to step 456 of FIG. 4D), is then displayed for the Holder.

If the Holder continues processing the action (step 412-Yes), the Holder is given the opportunity to create documents necessary to the completion of this stage of the action (step 422, FIG. 4B). Currently, only a seller's representation letter is required for most actions. A seller's representation letter includes various representations about how the stock certificates were acquired, limitations placed on the transference of the stock certificates, and whether the Holder is affiliated with the Issuer of the stock certificates. Additionally, a Rule 144 Form is required for Rule 144 process type actions. Currently, this document provides notice of a proposed sale of securities pursuant to Rule 144 under the Securities Act of 1933. However, the document requirements are dictated by SEC regulations and the preferences of the various entities involved in the processing of the action. Accordingly, embodiments of the invention are designed with enough flexibility to modify the document requirements for each stage of the action as needed. Additionally, the Holder can retrieve document templates from database 240 using Internet browser 340 and web pages from Website 230 for purpose of creating documents. As noted above, documents and other information is maintained in a Holder record in database 240. These document templates are preferably created when an account is created for the Holder. Essentially, these documents include any information deemed by the Holder, in accordance with SEC regulations, to be important. The Holder also has the option of importing documents or document templates from a different source (e.g., the memory of Holder computer 20, or any other source accessible by user computer 30). In either case, the Holder can view and edit the documents using a compatible word processor (e.g., Microsoft Word, Word Perfect, Adobe Acrobat). Additionally, the Holder can selectively ignore any document requirement imposed on the Holder. If so, the Holder is preferably prompted to enter an explanation in a dialog box. This information is then accessible by subsequent entities processing the action concerned about the absence of one or more documents. Generally, this occurs when a Holder, or other party at a different stage of the action, exchanges documents with another entity in the process without using the present invention.

At any time after the Holder begins creating documents, the Holder can suspend and save the action as described above with reference to steps 412-No, 414, and 416 (steps 424-No, 426, and 428 respectively).

The Holder can also continue the action (step 424-Yes). If so, controller 260 confirms that each required document is created or selectively ignored (step 430). If not, the Holder is returned to the previous step in order to complete creating documents (step 430-No). If on the other hand, controller 260 confirms that each required document is created or selectively ignored (step 430-Yes), the Holder is given an opportunity to review the action (step 432). During this review, the Holder preferably has the option of entering Broker identification information (e.g., Brokerage firm, Broker name, assistant name, e-mail address, phone number, fax number, etc.). Additionally, the Holder preferably has the option of entering identification information (e.g., agent firm, agent name, assistant name, e-mail address, phone number, fax number, etc.) of a person or entity responsible for filing forms required by the SEC or other agencies. Finally, the Holder can elect to review an automated notifications list upon completing the review and continuing to the next step of action processing.

At any time after the process of reviewing the action begins, the Holder can save and suspend the action as described above with reference to steps step 412-No, 414, and 416 (steps 434-No, 436, and 438 respectively).

If the Holder continues processing the action (step 434-Yes) and has elected to review the automated notifications list (step 440-Yes, FIG. 4C), the Holder is presented with a list of persons or entities notified when the Holder finally releases the action to the next stage of the process (step 442). The list includes identification information (e.g., firm, name, assistant name, e-mail address, phone number, fax number, etc.). The list is preferably initialized with data maintained in database 240. As noted above, the Holder record maintained in database 240 includes sub-records with links to stock certificate Issuers, Brokers, etc. These links are utilized by controller 260 to obtain updated contact information for each of these entities. Additionally, the Holder can when the account on server 20 is created for the Holder, or any time thereafter, specify persons or entities to be included in the list of person by default. This information is maintained in the Holder record and used to initialize the automated notifications list. Furthermore, the Holder is able to edit this list as needed.

At any time after the process of reviewing the automated notifications list begins, the Holder can suspend and save the action as described above with reference to steps step 412-No, 414, and 416 (steps 446-No, 452, and 454 respectively).

If the Holder continues processing the action after reviewing the automated notifications (step 446-Yes) or if the Holder did not elect to review the automated notifications after reviewing the action (step 434-Yes, step 440-No), the status of the action is updated (i.e., the action is released to the next stage) (step 448) and the notifications are sent to the defined recipients (step 450). The notifications alert the other parties about the release of the action to the next stage by the Holder. More specifically, the person or persons responsible for the completion of the next stage can access server 20 in order to execute their required steps. Updating the action status includes storing an indication as to which stage of the process the action is in. For example, the Holder has just released the action to Stage II of Process I. Generally, this means that a Broker selected by the Holder is now the party responsible for processing the action. Accordingly, the action record includes an entry indicating that the Broker is currently responsible for the action. Generally, after the action is released to the next stage, the Holder signs off of server 20 and exits the system. However, the Holder can also return to view the holdings data (as described above with reference to step 404) or view data related to actions already in progress (as described below with reference to step 456).

Controller 260 retrieves from database 240 and transfers to Holder computer 20 data relating to pending actions (i.e., actions that the Holder has initiated but have not been completed) (step 456, FIG. 4D). The data is then displayed to the Holder (step 458). For each action, an entry including the action-ID, action status, stock certificate fund, stock certificate numbers, number of shares included in the action, Brokerage firm (if entered), stock certificate Issuer, Legal Counsel (if entered), and Transfer Agent (if entered) is displayed. If the Holder suspended and saved the action before releasing it to the next stage, an entry for that action is included in the list of pending actions. In that case, the status of the action reflects that the Holder is still the responsible party for that particular action. If on the other hand, the Holder has already released the action to the next stage, the status displayed is indicative of the current stage of processing (e.g., Broker, Issuer, Legal Counsel, or Transfer Agent).

The Holder can view details of a listed action or sign-off of server 20 (step 460). If the Holder chooses to view details of a listed action (step 460-Yes), controller 260 retrieves and transfers additional action data to user computer 30 (step 462), which is displayed for the Holder (step 464). This data includes for example, status comments entered by the Holder or any other party that has processed the action. The Holder can also view documents created by the Holder and other entities during later stages of action processing. The Holder can also continue processing an action that has not been released to the next stage by the Holder (step 468-Yes) or return to the displayed list of pending actions (step 468-No). If the Holder continues processing an action (step 468-Yes), controller 260 returns the Holder to the step at which the Holder elected to suspend and save the action (step 470). For example, if the Holder elected to suspend and save the action while reviewing the action (step 432), the Holder is returned, by controller 260, to step 432 as described above. Basically, this is accomplished by displaying the data and options that were available when the Holder last accessed step 432.

The next stage of the process is Stage II of Process I and is generally completed by a Brokerage firm selected by the Holder. As noted above, a Brokerage firm is not needed if the Holder elects only to delegend shares of a stock certificate rather than delegend and sell shares of a stock certificate. Additionally, the Issuer could actually complete what is described as Stage III of Process I before Stage II of Process I is completed. The reason is that the Broker and Issuer are concerned primarily with the activities of the Holder rather than each other. More specifically, the work completed by the Broker and Issuer is generally not interdependent. The processing steps executed during this stage are illustrated in FIGS. 5A-5C.

This stage begins with the Broker signing on to server 20 (step 500, FIG. 5A). The Broker can be prompted to access server 20 via e-mail, or other technique, when the Holder releases the action to Stage II. After the Broker is signed on, controller 260 retrieves from database 240 and transfers to user computer 30 data relating to pending actions that require processing by the Broker (step 502). The data is then displayed to the Broker (step 504). This data encompasses actions that were partially processed by the Broker and actions that have just entered or re-entered the stage of the Broker. For each action, an entry including the action-ID, action status, Holder, stock certificate fund, stock certificate numbers, number of shares included in the action, Issuer, Legal Counsel, and Transfer Agent is displayed.

When a Broker is ready to process the action (step 506-Yes), the Broker is given the opportunity to create documents necessary to the completion of the action (step 518). In particular, a Broker typically includes a Broker's representation letter. In this document, the Broker usually makes representations such as conducting the sale pursuant to “manner of sale restrictions” rules promulgated by the SEC. For example, some process types require advertisement restrictions for stock certificate sales. Additionally, S-3 prospectus delivery is required for some process types. Furthermore, 144, 144k, and 145 process types have sales volume restrictions.

For each required document, and any optional documentation, the Broker can retrieve a document template from database 240 using Internet browser 340 and web pages from Website 230. The Broker also has the option of importing a document from a different source. In either case, the Broker can view and edit the documents using a compatible word processor. Additionally, the Broker can ignore any required documents. If so, the Broker is preferably prompted to enter an explanation in a dialog box. This information is then accessible by subsequent users concerned about the absence of a document.

Any time after the process of creating documents begins, the Broker can suspend and save the action (step 520-No). The Broker is then prompted to enter status comments (step 526), which are saved with the action details in database 240 (step 522). Controller 260 then retrieves and transfers to user computer 30 data for all pending actions (step 502), which is displayed for the Broker (step 504) as described above.

The Broker can also choose to continue processing the action (step 520-Yes). If so, controller 260 confirms that each required document is created or selectively ignored (step 526). If not, the Broker is returned to the step of creating documents (step 526-No). If on the other hand, controller 260 confirms that each required document is created or selectively ignored (step 526-Yes), processing of the action continues.

The Broker is also given the opportunity to conduct a review of the action (step 530). Essentially, action data is displayed for the Broker again before the action is released by the Broker to the next stage. The Broker can also elect to review an automated notifications list upon completing the review and continuing to the next step of action processing.

Any time after the review begins, the Broker can suspend and save the action (step 532-No, FIG. 5B). The Broker is then prompted to enter status comments (step 534), which are saved with the action details in database 240 (step 536). Controller 260 then retrieves and transfers to user computer 30 data for all pending actions (step 502), which is displayed for the Broker (step 504) as described above.

If the Broker chooses to continue processing the action (step 532-Yes, FIG. 5B) and has elected to review the automated notifications list (step 538-Yes), the Broker is presented with a list of persons or entities that are notified when the Broker finally releases the action to the next stage (step 540). The list includes identification information (e.g., firm, name, assistant name, e-mail address, phone number, fax number, etc.). The list is preferably initialized with data maintained in database 240 and updated by the Holder in step 442.

Any time after the process of reviewing the automated notifications list begins, the Broker can suspend and save the action (step 544-No). If the Broker does so, the Broker is prompted to enter status comments (step 550), which are saved with action details in database 240 (step 552). Controller 260 then retrieves and transfers to user computer 30 data for all pending actions (step 502), which is displayed for the Broker (step 504) as described above.

If the Broker continues processing the action after reviewing the automated notifications (step 544-Yes) or if the Broker did not elect to review the automated notifications after reviewing the action (step 532-Yes, step 544-No), the status of the action is updated (i.e., the action is released to the next stage) (step 546) and the notifications are sent to the defined recipients (step 548).

The next stage of the process is Stage III of Process I and is generally completed by the Issuer of the selected one or more stock certificates involved in the action. These processing steps are illustrated in FIGS. 6A-6C.

This stage begins with the Issuer signing on to server 20 (step 600, FIG. 6A). The Issuer can be prompted to access server 20 via e-mail, or other technique, when the Holder or Broker releases the action to Stage III. After the Issuer is signed on, controller 260 retrieves from database 240 and transfers to user computer 30 data relating to pending actions that require processing by the Issuer (step 602). The data is then displayed to the Issuer (step 604). This data encompasses actions that were only partially processed by the Issuer and actions that have just entered or re-entered (i.e., not approved by subsequent stages) this stage. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, the Issuer can process an action (step 606-Yes) or sign-off of server 20 (step 606-No). If the Issuer chooses to process an action (step 606-Yes), controller 260 retrieves and transfers additional action data and action documents to user computer 30 (step 608). The additional action data is displayed for the Issuer (step 610). This additional action data includes for example, status comments submitted during any stage and reasons for not approving the action during subsequent stages.

The Issuer then has the option to review the work completed for the action in earlier stages (step 612). Essentially, this involves reviewing the documentation completed in earlier stages. For example, the documents typically included a seller's representation letter, Rule 144 Form, and Broker's representation letter. However, the Issuer need not review this documentation since the Issuer typically does not issue a representation letter. On the other hand, certain events preclude some Holders from selling stock certificates and the Issuer may want to monitor the sale of its stock certificate in conjunction with these events. Such events occur when, for example, a Holder is also a “corporate insider” of the Issuer and the Issuer will soon issue, or has recently issued, and announcement that adversely or positively affects the price of the selected stock certificate. Another example, is an agreement, not reflected on the face of the selected stock certificate, between the Holder—who is also a “corporate insider” of the Issuer—and the Issuer to not sell the selected stock certificate during the current time period. Access to these documents is provided on the display by, for example, a hyperlink. Once selected by the Issuer, a compatible word processor is used to display the contents of the document. After reviewing the action, the Issuer has the option to approve the steps taken for the action prior to Stage III (step 614). If the Issuer does not approve the action (step 614-No), controller 260 prompts the Issuer to submit a reason for not approving the action (step 616). Controller 260 then updates the status of the action (step 618), which also includes saving the reasons for not approving the action in database 240, and sending notifications to the person or entities notified in step 450 and 548 (step 620). Controller 260 then retrieves and transfers to user computer 30 data for all actions pending Issuer intervention (step 602), which is displayed for the Issuer (step 604) as described above.

If the Issuer approves the action (step 614-Yes), the Issuer is given the opportunity to create documents necessary to the completion of the action (step 622, FIG. 6B). To complete this step of the process, the Issuer can retrieve document templates from database 240 using Internet browser 340 and web pages from Website 230. The Issuer also has the option of importing a document or document template from a different source. In either case, the Issuer can view and edit the documents using a compatible word processor. Additionally, the Issuer can choose to ignore the document requirements. If so, the Issuer is preferably prompted to enter an explanation in a dialog box. This information is then accessible by other users concerned about the absence of one or more documents.

The Issuer is also preferably given, at this step of the process, the option of specifying the next person within the Issuer entity to review the action. Often, more than one person must review an action before it is released to the next stage. For example, an Issuer might have a junior employee review the action before a more senior employee provides a final review of the action. The present invention is designed to allow the Issuer to specify in advance the names and order of the reviewers within the organization. Thus, when an action is released to the Issuer stage, a designated person is given the task of reviewing the action first. Further, at this step of the process, controller 260 can automatically include the name and email address of the next person within the Issuer entity to review the action. If the final reviewer has been reached, no such information is included. Additionally, the Issuer has the option of altering this information as needed (e.g., change the next person within Issuer entity to review the action).

At any time after beginning the process of creating documents, the Issuer can suspend and save the action (step 624-No). The Issuer is then prompted to enter status comments (step 626), which are saved with the action details in database 240 (step 628). Controller 260 then retrieves and transfers to user computer 30 data for all pending actions (step 602), which is displayed for the Issuer (step 604) as described above.

The Issuer can also continue processing the action (step 624-Yes). If so, controller 260 confirms that each required document has been created or selectively ignored by the Issuer (step 630). If not, the Issuer is returned to the step of creating documents (step 630-No). If on the other hand, controller 260 confirms that each required document is created or selectively ignored (step 630-Yes), processing of the action continues.

The next step depends upon whether an additional person within the Issuer entity is specified in step 622 (step 632). If so (step 632-Yes), controller 260 updates the action status (step 633) and sends a notification to the person designated in step 622 (step 634). In a preferred embodiment of the invention, only the person designated in step 622 is notified so that the Issuer can maintain a certain amount of internal autonomy. Thus, persons outside of the Issuer organization know only that the Issuer entity is still processing the action, but do not know with certainty the specific individual currently responsible for the action. Controller 260 then retrieves and transfers to user computer 30 data for all pending actions (step 602), which is displayed for the Issuer (step 604) as described above.

If an additional person is not designated to review the action in step 622, the Issuer is given the opportunity to conduct a final review of the action (step 635). Essentially, action data is displayed for the Issuer again before the action is released by the Issuer to the next stage. The Issuer can also elect to review an automated notifications list upon completing the review and continuing the action processing.

Any time after the final review begins, the Issuer can suspend and save the action (step 636-No). The Issuer is then prompted to enter status comments (step 638), which are saved with the action details in database 240 (step 640). Controller 260 then retrieves and transfers to user computer 30 data for all pending actions (step 602), which is displayed for the Issuer (step 604) as described above.

If the Issuer chooses to continue processing the action (step 636-Yes) and has elected to review the automated notifications list (step 642-Yes, FIG. 6C), the Issuer is presented with a list of persons or entities that are notified when the Issuer finally releases the action to the next stage of the action (step 644). The list includes identification information (e.g., firm, name, assistant name, e-mail address, phone number, fax number, etc.). The list is preferably initialized with data maintained in database 240 and updated by the Holder in step 442 and the Broker in step 540.

Any time after the process of reviewing the automated notifications list begins, the Issuer can suspend and save the action (step 648-No). If the Issuer does so, the Issuer is prompted to enter status comments (step 654), which are saved with action details in database 240 (step 656). Controller 260 then retrieves and transfers to user computer 30 data for all pending actions (step 602), which is displayed for the Issuer (step 604) as described above.

If the Issuer chooses to continue processing the action after reviewing the automated notifications (step 648-Yes) or if the Issuer did not elect to review the automated notifications after reviewing the action (step 636-Yes, step 642-No), the status of the action is updated (i.e., the action is released to the next stage) (step 650) and the notifications are sent to the defined recipients (step 652).

The next stage of the process is Stage IV of Process I and is generally completed by Legal Counsel working for the Issuer. Generally, smaller Issuers rely upon law firms to provide an opinion letter, which states that the action conforms to SEC regulations. However, larger Issuers often maintain attorneys on staff, so hiring an outside law firm is not required. Nevertheless, an opinion letter is still required, so an attorney, whether from the staff of the Issuer or from an outside law firm, must complete this stage of the process. To deal with either situation effectively and seamlessly, the present invention preferably does not differentiate between the two. The attorney responsible for the letter and that attorney's, partners, associates, and assistants are designated by the Issuer as being responsible for drafting an opinion letter. It just so happens that at times, these people are actually staff members of the Issuer.

Additionally, the processing steps executed during the stage completed by the attorney are identical to the processing steps completed by the Issuer as described in steps 600-656 of FIGS. 6A-6C and will not be repeated now in their entirety. However, some steps are substantively different, and those steps will be discussed.

In step 612, the Legal Counsel is given the opportunity to review the documentation produced in earlier stages. Since the Legal Counsel issues an opinion letter, as described below, the review conducted by the Legal Counsel is much more thorough and exacting than in other stages of the action. For example, the Legal Counsel confirms that representations made by the Holder and the Broker are accurate (e.g., adequacy of the representations, and that the trade date matches the date of the seller's representation letter), that the action is in compliance with applicable regulations, and that all necessary documents are created or accounted for and valid (e.g., the Rule 144 Form information such as sales by the Holder within the last three months is disclosed therein).

If the Legal Counsel does not approve of the action (step 614), the Legal Counsel submits one or more reasons for not doing so (step 616). The Legal Counsel can also specify a specific stage to which the action is sent. For example, if the Legal Counsel determines that the Holder made a mistake, the Legal Counsel can send the action back to Stage I. Regardless of which specific stage the action is sent, notifications are sent to the entities notified when Stage II is completed (step 620).

Another critical distinction between Stage III and Stage IV is step 622. In this step, Legal Counsel creates, among other documents, a legal opinion. The legal opinion directs the Transfer Agent to process the action.

The next and final stage of the process is Stage V of Process I and is generally completed by a Transfer Agent. The Transfer Agent actually exchanges unrestricted shares for the restricted shares selected by the Holder. In so doing, the Transfer Agent relies, in particular, on the opinion letter drafted by the Legal Counsel. Without this letter, a Transfer Agent will not exchange unrestricted shares for restricted shares. The processing steps executed during the stage completed by the Transfer Agent are illustrated in FIGS. 7A-7C.

This stage begins with the Transfer Agent signing on to server 20 (step 700, FIG. 7A). After the Transfer Agent is signed on, controller 260 retrieves from database 240 and transfers to user computer 30 data relating to pending actions that require processing by the Transfer Agent (step 702). The data is then displayed to the Transfer Agent (step 704). This data encompasses actions that were partially processed by the Transfer Agent and actions that have just entered or re-entered Stage V. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, the Transfer Agent can process an action (step 706-Yes) or sign-off of server 20 (step 706-No). When the Transfer Agent chooses to process an action (step 706-Yes), controller 260 retrieves and transfers additional action data and action documents to user computer 30 (step 708). The additional action data is displayed for the Transfer Agent (step 710).

The Transfer Agent then has the option to review the work completed for the action (step 712). Essentially, this involves reviewing the documentation completed in earlier stages. Typically, a Transfer Agent is only concerned about the legal opinion. Access to the documents is provided on the display by, for example, a hyperlink. Once selected, the Transfer Agent selects a document, and a compatible word processor is used to display the contents of the document. Additionally, the Transfer Agent requires the original selected restricted stock certificates (with each signed by the Holder) or a Stock Power and a Medallion or Bank Guaranty to guarantee the signatures. Furthermore, corporate Holders are also required to deliver a corporate stock transfer form to the Transfer Agent.

After reviewing the action, the Transfer Agent has the option to approve the action (step 714). If the Transfer Agent does not approve the action (step 714-No), controller 260 prompts the Transfer Agent to submit a reason for not approving the action (step 716). Controller 260 then updates the status of the action (718), which includes saving the reasons for not approving the action in database 240, and sending notifications to the person or entities notified in earlier stages (step 720). Controller 260 then retrieves and transfers to user computer 30 data for all pending actions (step 702), which is displayed for the Transfer Agent (step 704) as described above.

If the Transfer Agent approves the action (step 714-Yes), the Transfer Agent is given the opportunity to create documents necessary to the completion of the action (step 722, FIG. 7B). For each of document, the Transfer Agent can retrieve a document template from database 240 import the document from a different source. In either case, the Transfer Agent can view and edit the documents using a compatible word processor. Additionally, the Transfer Agent can ignore document requirements. If so, the Transfer Agent is preferably prompted to enter an explanation in a dialog box. This information is then accessible by subsequent users concerned about the absence of a document.

At any time after the process of creating documents begins, the Transfer Agent can suspend and save the action (step 724-No). The Transfer Agent is then prompted to enter status comments (step 726), which are saved with the action details in database 240 (step 728). Controller 260 then retrieves and transfers to user computer 30 data for all pending actions (step 702), which is displayed for the Transfer Agent (step 704) as described above.

The Transfer Agent can also choose to continue the action (step 724-Yes). If so, controller 260 confirms that each required document is created or selectively ignored (step 730). If not, the Transfer Agent is returned to the step of creating documents (step 730-No). If on the other hand, controller 260 confirms that each required document is created or selectively ignored (step 730-Yes), processing of the action continues.

The Transfer Agent is then given the opportunity to conduct a final review the action (step 732). Essentially, action data is displayed for the Transfer Agent again before the action is released by the Transfer Agent to the next stage. The Transfer Agent can also elect to review an automated notifications list upon completing the review and continuing to the next step of action processing.

Any time after the final review begins, the Transfer Agent can suspend and save the action (step 734-No). The Transfer Agent is then prompted to enter status comments (step 736), which are saved with the action details in database 240 (step 738). Controller 260 then retrieves and transfers to user computer 30 data for all pending actions (step 702), which is displayed for the Transfer Agent (step 704) as described above.

If the Transfer Agent chooses instead to close the action (step 734-Yes) and has elected to review the automated notifications list (step 740-Yes, FIG. 7C), the Transfer Agent is presented with a list of persons or entities that are notified when the Transfer Agent finally releases the action to the next stage of action (step 742). The list includes identification information (e.g., firm, name, assistant name, e-mail address, phone number, fax number, etc.). The list is preferably initialized with data maintained in database 240 and updated by the Holder in step 442 of FIG. 4C, the Issuer and Legal Counsel in step 654 of FIG. 6C, and the Broker in step 540 of FIG. 5C.

At any time after the process of reviewing the automated notifications list begins, the Transfer Agent can suspend and save the action (step 746-No). If the Transfer Agent does so, the Transfer Agent is prompted to enter status comments (step 748), which are saved with action details in database 240 (step 750). Controller 260 then retrieves and transfers to user computer 30 data for all pending actions (step 702), which is displayed for the Transfer Agent (step 704) as described above.

If the Transfer Agent chooses to close the action after reviewing the automated notifications (step 746-Yes) or if the Transfer Agent did not elect to review the automated notifications after reviewing the action (step 734-Yes, step 740-No), the status of the action is updated (i.e., the action is closed) (step 752) and the notifications are sent to the defined recipients (step 754).

As noted above, the Holder may elect to delegend only some of the shares included in a selected restricted stock certificate. When this occurs, the selected restricted stock certificate entry in the holdings data is modified to reflect the reduced number of shares remaining. This prevents a Holder from attempting to delegend shares no longer available. When the delegending process is closed by a Transfer Agent, controller 260 or the Transfer Agent closing the delegending process creates a new entry in the holdings data to represent a newly created restricted stock certificate that includes the remaining shares of the selected restricted stock certificate and deletes the selected restricted stock certificate entry (step 756). This process is required because the Transfer Agent must create a new restricted stock certificate and destroy the previous stock certificate. All of the data from the previous restricted stock certificate entry is incorporated in the new entry. One exception to this is that the number of shares issued data and the number of shares remaining data is set to reflect the reduced number of shares available. Additional data that is changed includes the date of creation and the stock certificate number.

The Transfer Agent also issues one or more unrestricted stock certificates reflecting shares of each restricted stock certificates selected for delegending. If as described above, only a portion of one or more selected restricted stock certificates is part of the delegending process, the Transfer Agent also issues one or more restricted stock certificates having a proportionately reduced number of shares.

The Transfer Agent is also given the option (step 758-Yes) to update the stock certificate entries created for each partner as a result of the distribution action (step 760). If the Transfer Agent declines, Controller 260 then retrieves and transfers to user computer 30 data for all pending actions (step 702), which is displayed for the Transfer Agent (step 704) as described above.

As described above, a VC fund holds stock certificates that are distributed to the partners of the VC fund. Generally, the distribution process involves breaking down a stock certificate according to the ownership position of each limited partner. The positions held by each partner may or may not be equal. Either way, a distribution table controls the distribution process as will be described below.

Often times, the stock certificates distributed are restricted. Accordingly, shares of stock certificates distributed by a VC fund may or may not be restricted. When the stock certificates selected for distribution are restricted, the resultant stock certificates distributed to the partners of the VC fund are restricted as well. In such case, each partner receiving a distribution of restricted stock certificates typically uses the delegending process described in detail with reference to FIGS. 4A-10C to delegend and sell the restricted stock certificates. Generally, the sale takes place concurrently or a short while after the distribution is completed. Accordingly, in this invention, documentation utilized in the delegending process described in detail with reference to FIGS. 4A-10C is often prepared during the distribution process.

FIGS. 8A-8D illustrate the processing steps executed in the first stage of the distribution process—Stage I of Process II. Stage I begins when a representative of a VC fund (“VC fund”) signs on to server 20 through the use of user computer 30. More specifically, the VC fund accesses Website 230 using Internet browser 340 and signs on to server 20 using a user name and password combination (step 800, FIG. 8A). After the sign-on is completed, controller 260 determines if the VC fund has any pending actions (e.g., a pending action to distribute a stock certificate held by the VC fund) by reference to records of the VC fund maintained in database 240 (step 802). If so, processing step 862 of FIG. 8D, as described below, is executed. If not, controller 260 retrieves and transfers holdings data of the VC fund from database 240 to user computer 30 (step 804).

This information is then displayed by Internet browser 360 on i/o device 320 (step 806). The holdings data displayed is preferably grouped by each stock certificate held by the VC fund. Additionally, the displayed holdings data preferably includes the Issuer of the stock certificate, the fund to which the stock certificate belongs, the stock certificate number, the acquisition date of the stock certificate, the number of shares issued, the number of remaining shares, and the process type.

The VC fund then has the option to create an action to distribute a specified number of shares from one or more stock certificates. However, the VC fund cannot, in a single action, includes stock certificates of different process types (e.g., Rule 144, Rule 701, Rule 144K) nor stock certificates issued by different Issuers.

If the VC fund does not create an action (step 808-No), the VC fund signs off of server 20.

If however, the VC fund chooses to create an action (step 808-Yes), an action-ID is created by controller 260 (step 809) and action verification data is displayed (step 810). This data includes the Issuer of the one or more stock certificate selected, the stock certificate number of each stock certificate selected, and the total number of shares remaining for each stock certificate selected. The action-ID created by controller 260 is preferably displayed as well. Furthermore, the VC fund is presented with a standard text box for the entry of the number of shares to be acted upon for each stock certificate selected. The data also preferably includes additional information for the purpose of avoiding errors or delays in the process of completing the selected action. For example, the action verification data can include a reminder about the regulatory and legal responsibilities imposed on the VC fund during this process.

Upon entering the desired number of shares and reviewing the displayed information, the VC fund has the option to continue the process (i.e., verify the action) or suspend and save the action (step 812).

If the VC fund suspends and saves the action (step 812-No), the VC fund is prompted to enter status comments regarding the action (step 814). Controller 260 then saves the action details (e.g., the number shares of each selected stock certificate as defined by the VC fund) and status comments in database 240 (step 816). Action status data, as described below (beginning with reference to step 862 of FIG. 8D), is then displayed for the VC fund.

If the VC fund continues processing the action (step 812-Yes), the VC fund is prompted to create a distribution table (step 818, FIG. 8B). A distribution table specifies the share each partner of the VC fund is to receive as a result of the distribution. To complete this task, the VC fund preferably has a number of options. For example, the VC fund can request the retrieval of a distribution table template from database 240. When the VC fund proceeds in this fashion, controller 260 determines the share each VC fund partner is to receive by reference to the share of each selected stock certificate owned by each limited partner. For example, if only one stock certificate is included in an action and a first partner of the VC fund owns 40% of the stock certificate, the first partner of the VC fund will receive 40% of the distribution. Another option is to import a distribution table from a different source (e.g., the memory of user computer 30). In this case, the VC fund must determine the share of the distribution received by each limited partner. Either way, the VC fund can view and edit the distribution table using a compatible word processor or spreadsheet program (e.g., Microsoft Excel or Corel Quattro Pro). Additionally, the VC fund can selectively ignore the distribution table requirement. If so, the VC fund is preferably prompted to enter an explanation in a dialog box. This information is accessible by subsequent users concerned about the absence of the distribution table.

At any time during the process of creating a distribution table, the VC fund can suspend and save the action (step 820-No). The VC fund is then prompted to enter status comments regarding the action (step 822). Controller 260 then saves the action details and status comments in database 240 (step 824). Action status data, as described below (beginning with reference to step 862 of FIG. 8D), is then displayed for the VC fund.

The VC fund can also continue the process after creating a distribution table (step 820-Yes). If so, controller 260 confirms that the distribution table has been created or selectively ignored by the VC fund (step 826). If not, the VC fund is returned to the step of creating a distribution table (step 826-No).

If on the other hand, controller 260 confirms that the distribution table has been created or selectively ignored by the VC fund (step 826-Yes), the VC fund is given the opportunity to create documents necessary to the completion of the action (step 828). Examples of such documents include a separate distribution letter to each limited partner, Legal Counsel, a Transfer Agent, and if necessary, a Broker. A Broker is typically notified if a sale is likely to follow the distribution action. These letters are typically the same for each entity named, and serve as notification of the distribution action. In this stage, the term “required” is used loosely. The distribution letters are not required by any particular entity or regulatory authority; however, embodiments of the invention preferably allow the generation of these documents to facilitate the process. Another document usually created during this stage is an Agreement of transferee. This document is an agreement imposes on the party receiving the shares as a result of the distribution restrictions imposed on the current holder of the stock certificate. Furthermore, the VC fund can create documents in anticipation of a sale following the distribution action as noted above.

This documentation includes, for example, a Rule 144 Form, seller's representation letter, Broker's representation letter, or other documentation. While this documentation is not required at this stage, a VC fund often includes the documentation as a service to the partners. For each required document, the VC fund can retrieve document templates from database 240 using Internet browser 340 and web pages from Website 230. These documents are preferably created when an account is created for the VC fund. Essentially, these documents include any information deemed by the VC fund, in accordance with SEC regulations, to be important to the distribution action. The VC fund also has the option of importing a document from a different source (e.g., the memory of user computer 30). In either case, the VC fund can view and edit the documents using a compatible word processor. Additionally, the VC fund can selectively ignore the documentation requirements. If so, the VC fund is preferably prompted to enter an explanation in a dialog box. This information is then accessible by subsequent users concerned about the absence of required documentation.

At any time during the process of creating documentation, the VC fund can suspend and save the action (step 830-No). The VC fund is then prompted to enter status comments regarding the action (step 832). Controller 260 then saves the action details and status comments in database 240 (step 834). Action status data, as described below (beginning with reference to step 862 of FIG. 8D), is then displayed for the VC fund.

The VC fund can also continue the process (step 830-Yes). If so, controller 260 confirms that each required document has been created or selectively ignored by the VC fund (step 836). If not, the VC fund is returned to the step of creating documents (step 836-No). If on the other hand, controller 260 confirms that each required document has been created or selectively ignored by the VC fund (step 836-Yes), the VC fund is given an opportunity to review the action (step 838). During this review, the VC fund preferably has the option of entering Broker identification information (e.g., Brokerage firm, Broker name, assistant name, email address, phone number, fax number, etc.). Finally, the VC fund can elect to review an automated notifications list upon completing the review and continuing action processing.

At any time during the process of creating documentation, the VC fund can suspend and save the action (step 840-No, FIG. 8C). If so, the VC fund is prompted to enter status comments regarding the action (step 842). Controller 260 then saves the action details and status comments in database 240 (step 844). Action status data, as described below (beginning with reference to step 862 of FIG. 8D), is then displayed for the VC fund.

If the VC fund continues processing the action (step 840-Yes) and has elected to review the automated notifications list (step 840-Yes), the VC fund is presented with a list of persons or entities that are notified when the VC fund releases the action to the next stage (step 842). The list includes identification information (e.g., firm, name, assistant name, e-mail address, phone number, fax number, etc.). The list is preferably initialized with data maintained in database 240. This data is provided by a VC fund when an account is created for the VC fund on server 20.

At any time during the process of creating documentation, the VC fund can suspend and save the action (step 852-No). If so, the VC fund is prompted to enter status comments regarding the action (step 858). Controller 260 then saves the action details and status comments in database 240 (step 860). Action status data, as described below (beginning with reference to step 862 of FIG. 8D), is then displayed for the VC fund.

If the VC fund continues processing the action after reviewing the automated notifications (step 852-Yes) or if the VC fund did not elect to review the automated notifications after reviewing the action (step 846-Yes, step 852-No), the status of the action is updated and the action is released to the next stage (step 854). Notifications of the release of the action to the next stage are also sent to the defined recipients (step 856).

Controller 260 then preferably creates for each partner of the VC fund 1) an action to delegend the stock certificates to be received as a result of the distribution action, and 2) a new entry in the holdings data reflecting the stock certificate to be received as a result of the distribution action (step 857). Because stock certificates have not yet been issued by the Transfer Agent to any of the partners, the stock certificate described in the holdings data as a result of this step does not include a stock certificate number. However, information describing the stock certificate (e.g., Issuer of the stock, legend type, legend text, affiliate status of the VC fund, date of acquisition, date of automatic legend restriction change or termination, manner of acquisition, broker information if relevant, and links to the records of the Issuer, and Broker as needed) is obtained from the sub-record in database 240 describing the stock certificate selected for distribution. This information is also reflected in each action to delegend the stock certificate created in step 857. Accordingly, the various entities involved in the delegending process as described above have sufficient information to complete the delegending process even though the distribution process is not yet complete. Each action created in step 857 is displayed to the Transfer Agent selected to complete the distribution action as described in step 1002 below. The Transfer Agent can then determine what type of certificate to create as a result of the distribution action. For example, if a partner designated to receive a portion of the distributed stock certificate chooses to release an action created in step 857 to the next stage, the Transfer Agent will not create a restricted stock certificate for delivery to the limited partner. Instead, the Transfer Agent will wait until the delegending process is complete to create an unrestricted stock certificate for delivery to the limited partner. This allows the Transfer Agent to avoid creating a restricted stock certificate that will be replaced at the close of the delegending process.

Generally, after the action is released to the next stage, the VC fund signs off of server 20 and exits the system. However, the VC fund can also return to view the holdings data (as described above with reference to step 804) or view data related to pending actions (as described below with reference to step 862).

Controller 260 retrieves from database 240 and transfers to user computer 30 data relating to pending actions (step 862). The data is then displayed to the VC fund (step 864). This data encompasses actions that were and were not released by the VC fund to the next stage. For each action, an entry including the action-ID, action status, stock certificate fund, stock certificate numbers, number of shares included in the action, Brokerage firm, stock certificate Issuer, Legal Counsel, and Transfer Agent is displayed. If the VC fund suspended and saved the action, the status of the action indicates that the VC fund has not released the action yet. If on the other hand, the VC fund has already released the action to the next stage of processing, the status displayed is indicative of the current stage of processing (e.g., Legal Counsel or Transfer Agent).

The VC fund can view details of a listed action or sign-off of server 20 (step 866). If the VC fund chooses to view details of a listed action (step 866-Yes), controller 260 retrieves and transfers additional action data to user computer 30 (step 868), which is displayed for the VC fund (step 870). If the VC fund is an action that has not been released to the next stage by the VC fund, the VC fund can continue processing the action (step 872-Yes) or return to the displayed list of pending actions (step 872-No). If the VC fund continues processing an action (step 868-Yes), controller 260 returns the VC fund to the step of the process at which the VC fund elected to suspend and save the action (step 874).

The next stage of the process, Stage II of Process II, is generally completed by Legal Counsel. Essentially, an attorney has to issue a legal opinion representing that the distribution is not in violation of applicable regulations. Similar to the delegending process, Legal Counsel may or may not consist of employees of the Issuer of the selected stock certificates. The processing steps executed during the stage are illustrated in FIGS. 9A-9C.

This stage begins with the attorney signing on to server 20 (step 900, FIG. 9A). After Legal Counsel is signed on, controller 260 retrieves from database 240 and transfers to user computer 30 data relating to pending actions that require processing by Legal Counsel (step 902). The data is then displayed to Legal Counsel (step 904). This data encompasses actions that were partially processed by Legal Counsel and actions that have just entered or re-entered the stage completed by Legal Counsel. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, Legal Counsel can process an action (step 906-Yes) or sign-off of server 20 (step 906-No). If Legal Counsel chooses to process an action (step 906-Yes), controller 260 retrieves and transfers additional action data and action documents to user computer 30 (step 908). The additional action data is displayed for Legal Counsel (step 910).

Legal Counsel then has the option to review the work completed for the action (step 912). This step includes reviewing the documentation completed in earlier stages. Access to the documents is provided on the display by, for example, a hyperlink. When Legal Counsel has selected a document, a compatible word processor is used to display the contents of the document. However, since none of the documentation created in Stage I of Process II is absolutely required, the review process focuses on other factors. For example, the Legal Counsel confirms that the representative of the VC fund has the authority to distribute the stock certificate. Occasionally, a VC fund mistakenly selects the wrong stock certificate for distribution. The Legal Counsel also checks for 1) a pending corporate transaction, 2) material new announcement, and 3) a secondary offering by the Issuer of the selected stock certificate. Generally, if the Holder is affiliated with the Issuer, these types of activities preclude a distribution action.

After reviewing the action, Legal Counsel has the option to approve the action (step 914). If Legal Counsel does not approve the action (step 914-No), controller 260 prompts Legal Counsel to submit a reason for not approving the action (step 916). Controller 260 then updates the status of the action (918), which includes saving the reason or reasons for not approving the action in database 240, and sends notifications to the person or entities notified in step 856 of FIG. 8C (step 920). Controller 260 then retrieves and transfers to user computer 30 data for all actions pending Legal Counsel interaction (step 902), which is displayed for Legal Counsel (step 904) as described above.

If Legal Counsel approves the action (step 914-Yes), Legal Counsel is given the opportunity to create documents necessary to the completion of the action (step 922, FIG. 9B). Essentially, this means that Legal Counsel generates an opinion letter stating approval for the distribution action. The precise documents required are dictated by SEC regulations. Accordingly, embodiments of the invention are designed with enough flexibility to modify the documents required at any stage of the process. For each of these documents, and any other optional documentation, Legal Counsel can retrieve document templates from database 240 using Internet browser 340 and web pages from Website 230. These documents are preferably created when an account is created for Legal Counsel. Essentially, these documents include any information deemed by Legal Counsel, in accordance with SEC regulations, to be important to the distribution process. Legal Counsel also has the option of importing a document from a different source (e.g., the memory of user computer 30). In either case, Legal Counsel can view and edit the documents using a compatible word processor. Additionally, Legal Counsel can choose to ignore the document requirements. If so, Legal Counsel is preferably prompted to enter an explanation in a dialog box. This information is then accessible by subsequent users concerned about the absence of required documents.

Legal Counsel is also preferably given, at this step of the process, the option to specifying the next person within the Legal Counsel entity to review the action. Often, more than one person must review an action before the action is released to the next stage. The present invention is designed to allow Legal Counsel to specify in advance the names and order of reviewers within the organization. Thus, when the VC fund releases an action to Legal Counsel stage, a designated person is given the task of reviewing the action first. Further, at this step of the process, controller 260 can automatically display the name and email address of the next person within Legal Counsel to review the action. If the final reviewer has been reached, no such information is included.

At any time after the process of creating documents begins, Legal Counsel can suspend and save the action (step 924-No). Legal Counsel is then prompted to enter status comments (step 926), which are saved with the action details in database 240 (step 928). Controller 260 then retrieves and transfers to user computer 30 data for all pending actions (step 902), which is displayed for Legal Counsel (step 904) as described above.

Legal Counsel can also continue processing the action (step 924-Yes). If so, controller 260 confirms that each required document has been created or selectively ignored by Legal Counsel (step 930). If not, Legal Counsel is returned to the step of creating documents (step 930-No). If on the other hand, controller 260 confirms that each required document has been created or selectively ignored by Legal Counsel (step 930-Yes), processing of the action continues.

The next step executed depends upon whether an additional person within the Legal Counsel entity is specified in step 922 (step 932). If so (step 932-Yes), controller 260 updates the action status (step 933) and sends a notification to the person designated in step 922 (step 934). In a preferred embodiment of the invention, the parties notified according to the automated notification list discussed with reference to, for example, step 856, are not necessarily notified in this instance so that Legal Counsel can maintain a certain amount of internal autonomy. Thus, persons outside of the Legal Counsel organization know only that Legal Counsel is still processing the action. Controller 260 then retrieves and transfers to user computer 30 data for all pending actions (step 902), which is displayed for Legal Counsel (step 904) as described above.

If an additional person is not designated to review the action in step 922, Legal Counsel is given an opportunity to conduct a final review the action (step 935). Essentially, action data is displayed for Legal Counsel again before the action is released by Legal Counsel to the next stage. Legal Counsel can also elect to review an automated notifications list upon completing the review and continuing to the next step of action processing.

At any time after the final review begins, Legal Counsel can suspend and save the action (step 936-No). If so, Legal Counsel is then prompted to enter status comments (step 938), which are saved with the action details in database 240 (step 940). Controller 260 then retrieves and transfers to user computer 30 data for all pending actions (step 902), which is displayed for Legal Counsel (step 904) as described above.

If Legal Counsel chooses to continue processing the action (step 936-Yes) and has elected to review the automated notifications list (step 942-Yes, FIG. 9C), Legal Counsel is presented with a list of persons or entities that are notified when Legal Counsel finally releases the action to the next stage of the process (step 944). The list includes identification information (e.g., firm, name, assistant name, e-mail address, phone number, fax number, etc.). The list is preferably initialized with data maintained in database 240 and updated by the VC fund in step 848.

At any time after the process of reviewing the automated notifications list begins, Legal Counsel can suspend and save the action (step 948-No). If Legal Counsel does so, Legal Counsel is prompted to enter status comments (step 954), which are saved with action details in database 240 (step 956). Controller 260 then retrieves and transfers to user computer 30 data for all pending actions (step 902), which is displayed for Legal Counsel (step 904) as described above.

If Legal Counsel chooses to continue processing the action after reviewing the automated notifications (step 948-Yes) or if Legal Counsel did not elect to review the automated notifications after reviewing the action (step 936-Yes, step 942-No), the status of the action is updated (i.e., the action is released to the next stage) (step 950) and the notifications are sent to the defined recipients (step 952). The notifications alert the other parties about the release of the action to the next stage by Legal Counsel.

The next and final stage of the process, Stage III of Process II, is generally completed by a Transfer Agent. The Transfer Agent exchanges the selected stock certificates held by the VC fund for shares for stock certificates for each partner of the VC fund. In so doing, the Transfer Agent relies, in particular, on the opinion letter drafted by Legal Counsel. Without this letter, a Transfer Agent cannot legally exchange the shares. The processing steps executed during Stage III are illustrated in FIGS. 10A-10C.

This stage begins with the Transfer Agent signing on to server 20 (step 1000, FIG. 10A). After the Transfer Agent is signed on, controller 260 retrieves from database 240 and transfers to user computer 30 data relating to pending actions that require processing by the Transfer Agent (step 1002). The data is then displayed to the Transfer Agent (step 1004). This data encompasses actions that were partially processed by the Transfer Agent and actions that have just entered or re-entered Stage III. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, the Transfer Agent can process an action (step 1006-Yes) or sign-off from the server 20 (step 1006-No). If the Transfer Agent chooses to process an action (step 1006-Yes), controller 260 retrieves and transfers additional action data and action documents to user computer 30 (step 1008). The additional action data is displayed for the Transfer Agent (step 1010).

The Transfer Agent then has the option of reviewing the work completed for the action (step 1012). In part, this step includes reviewing the documentation completed in earlier stages. Typically, a Transfer Agent is only concerned about the legal opinion created by the Legal Counsel. Access to the documents is provided on the display by, for example, a hyperlink. Once the Transfer Agent has selected a document, a compatible word processor is used to display the contents of the document. Additionally, the Transfer Agent requires the original selected restricted stock certificates (with each signed by the VC fund) or a Stock Power and a Medallion or Bank Guaranty to guarantee the signatures.

After reviewing the action, the Transfer Agent has the option to approve the action (step 1014). If the Transfer Agent does not approve the action (step 1014-No), controller 260 prompts the Transfer Agent to submit a reason for not approving the action (step 1016). Controller 260 then updates the status of the action (1018), which includes saving the reasons for not approving the action in database 240, and sends notifications to the person or entities notified in step 856 of FIG. 8C, step 952 of FIG. 9C by a VC fund and Legal Counsel respectively (step 1020). When the action is not approved, responsibility for the action returns to an earlier stage. Controller 260 then retrieves and transfers to user computer 30 data for all pending actions (step 1002), which is displayed for the Transfer Agent (step 1004) as described above.

If the Transfer Agent approves the action (step 1014-Yes), the Transfer Agent is given the opportunity to create documents necessary to the completion of the action (step 1022, FIG. 10B). For each document created and reviewed, the Transfer Agent can retrieve a document template from database 240 using Internet browser 340 and web pages from Website 230. These documents are preferably created when an account is created for the Transfer Agent. Essentially, these documents include any information deemed by the Transfer Agent, in accordance with SEC regulations, to be important to the process of delegending stock certificates. The Transfer Agent also has the option of importing a document from a different source (e.g., the memory of user computer 30). In either case, the Transfer Agent can view and edit the documents using a compatible word processor. Additionally, the Transfer Agent can ignore the document requirements. If the Transfer Agent chooses to do so, he or she is preferably prompted to enter an explanation in a dialog box. This information is then be accessible by subsequent users concerned about the absence of one or more documents.

At any time after the process of creating documents begins, the Transfer Agent can suspend and save the action (step 1024-No). The Transfer Agent is then prompted to enter status comments (step 1026), which are saved with the action details in database 240 (step 1028). Controller 260 then retrieves and transfers to user computer 30 data for all pending actions (step 1002), which is displayed for the Transfer Agent (step 1004) as described above.

The Transfer Agent can also continue the process (step 1024-Yes). If so, controller 260 confirms that each required document has been created or selectively ignored by the Transfer Agent (step 1030). If not, the Transfer Agent is returned to the step of creating documents (step 1030-No). If on the other hand, system 10 confirms that each required document has been created or selectively ignored by the Transfer Agent (step 1030-Yes), processing of the action continues.

The Transfer Agent is given the opportunity to conduct a final review the action (step 1032). Essentially, action data is displayed for the Transfer Agent again before the action is closed by the Transfer Agent. The Transfer Agent can also elect to review an automated notifications list upon completing the review and continue processing the action.

At any time after the final review begins, the Transfer Agent can suspend and save the action (step 1034-No). The Transfer Agent is then prompted to enter status comments (step 1036), which are saved with the action details in database 240 (step 1038). Controller 260 then retrieves and transfers to user computer 30 data for all pending actions (step 1002), which is displayed for the Transfer Agent (step 1004) as described above.

If the Transfer Agent chooses instead to close the action (step 1034-Yes) and has elected to review the automated notifications list (step 1040-Yes, FIG. 10C), the Transfer Agent is presented with a list of persons or entities that are notified when the Transfer Agent finally releases the action to the next stage of the delegending process (step 1042). The list includes identification information (e.g., firm, name, assistant name, e-mail address, phone number, fax number, etc.).

At any time after the process of reviewing the automated notifications list begins, the Transfer Agent can suspend and save the action (step 1046-No). If so, the Transfer Agent is prompted to enter status comments (step 1048), which are saved with action details in database 240 (step 1050). Controller 260 then retrieves and transfers to user computer 30 data for all pending actions (step 1002), which is displayed for the Transfer Agent (step 1004) as described above.

If the Transfer Agent chooses to close the action after reviewing the automated notifications (step 1046-Yes) or if the Transfer Agent did not elect to review the automated notifications after reviewing the action (step 1034-Yes, step 1040-No), the status of the action is updated (i.e., the action is closed) (step 1052) and the notifications are sent to the defined recipients (step 1054).

As noted above, the VC fund may elect to distribute only some of the shares included in a selected restricted stock certificate. When this occurs, the selected restricted stock certificate entry in the holdings data is modified to reflect the reduced number of shares remaining. This prevents a VC fund from attempting to distribute shares no longer available. When the distribution process is closed by a Transfer Agent, controller 260 or the Transfer Agent closing the distribution process creates a new entry in the holdings data to represent a newly created restricted stock certificate that includes the remaining shares of the selected restricted stock certificate and deletes the selected restricted stock certificate entry (step 1056). This process is required because the Transfer Agent must create a new restricted stock certificate and destroy the previous stock certificate. All of the data from the previous restricted stock certificate entry is incorporated in the new entry. One exception to this is that the number of shares issued data and the number of shares remaining data is set to reflect the reduced number of shares available. Additional data that is changed includes the date of creation and the stock certificate number.

The Transfer Agent is also given the option (step 1058-Yes) to update the stock certificate entries created for each partner as a result of the distribution action (step 1060). If the Transfer Agent declines, Controller 260 then retrieves and transfers to user computer 30 data for all pending actions (step 1002), which is displayed for the Transfer Agent (step 1004) as described above.

As described above, the present invention relates to a system and method for creating and executing sale plans for shares of restricted stock certificates. In a preferred embodiment, the present system comprises a plurality of processing stages. For each stage, a plurality of parameters are defined that control the entities (e.g., persons or other entities) authorized to act with respect to the sale plan during the stage, and the actions these entities are authorized to take. In addition, a parameter is defined that specifies a set of stages (from the plurality of stages) to which the system may proceed at the discretion of an authorized entity when processing of a particular stage is completed. In this way, the preferred system and method facilitate efficient processing of the sale plan and eliminate errors that might otherwise occur due to unauthorized actors or actions.

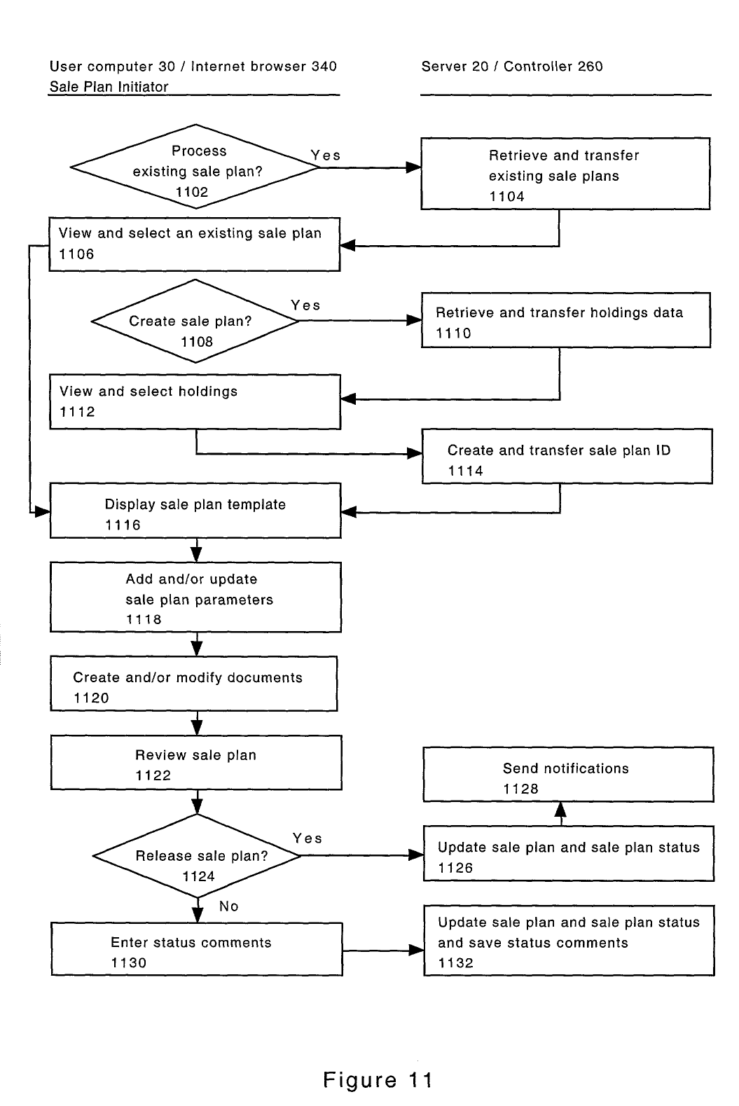

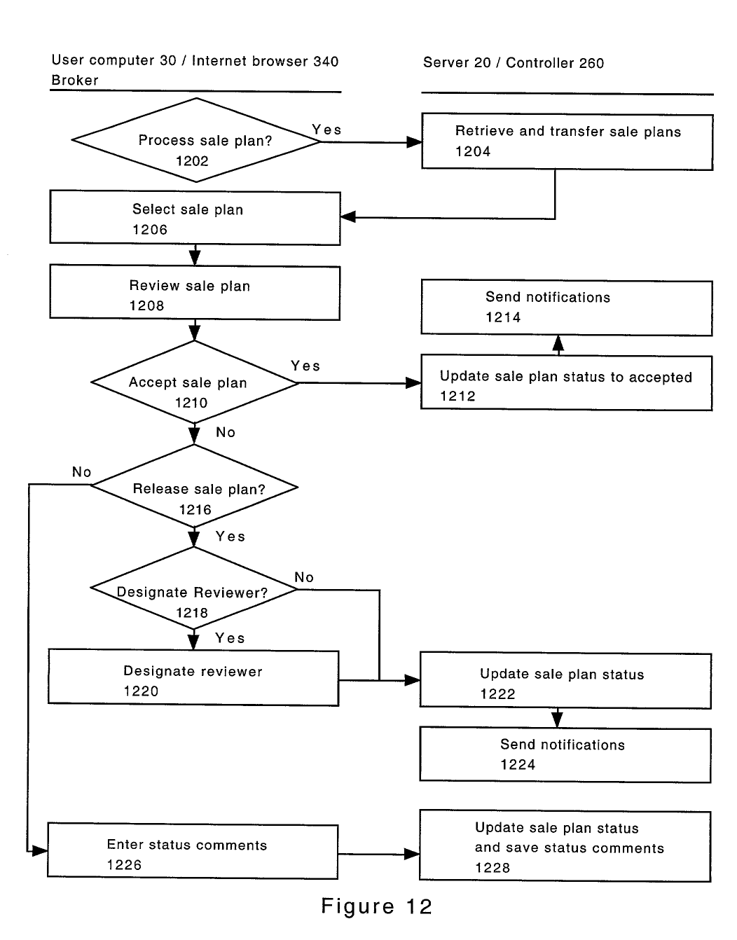

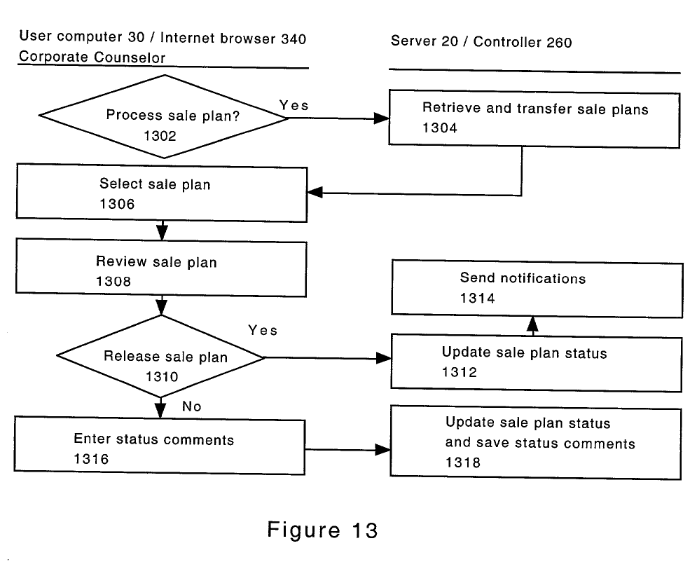

The process for creating and executing a sale plan preferably comprises five stages that create, modify, and process a variety of documents and sale plan parameters. The first stage is completed by a holder or a broker and a holder as described below in connection with FIG. 11. A sale plan is an agreement between a holder and a broker. Specifically, the holder and the broker enter into an agreement by which a specified number of restricted stock shares are to be sold by the broker on behalf of the holder. The second stage includes a review of the sale plan by the broker as described below in connection with FIG. 12. A corporate counselor then reviews the sale plan to determine whether it is in compliance with stated policies of the issuer of the restricted stock or whether the issuer is taking or about to take material actions. The third stage is described below in connection with FIG. 13. The fourth state includes a broker reviewing the sale plan again before allowing it to take effect (i.e., before sale plan creation is complete). The fourth stage is described below in connection with FIG. 12. The fifth stage comprises the execution of each sale specified in a sale plan. As described in detail above, FIGS. 4A-4D illustrate steps taken by a holder and the controller 260 to initiate the process of delegending and selling restricted stock. As a result of these steps, an action item is created. In the present invention, the controller 260 creates a similar action item for each sale specified in a sale plan—extracting required information from the sale plan. This action item preferably includes a link to a corresponding sale plan so that sale plan parameters, documents, etc. can be accessed as needed.

FIG. 11 illustrates processing steps included in a preferred embodiment of the present invention that represent the first stage of this process. As described above with reference to steps 400-406 or steps 500-504 a holder or broker (i.e., a sale plan initiator) signs-on to server 20 using a user name and password combination and receives a display of holdings data or action data respectively.

In addition to the options described above with reference to FIGS. 4A-4D and 5A-5B, the sale plan initiator can process an existing sale plan (step 1102) or create a sale plan (step 1108). If the sale plan initiator elects to process an existing sale plan (step 1102-Yes), the controller 260 scans the database 240 to locate existing sale plans (i.e., existing sale plans not yet released to the second stage) that are accessible to the sale plan initiator and transfers these sale plans to user computer 30 for display (step 1104). If the sale plan initiator is a holder, the scan is limited to sale plans created by the holder (i.e., the scan is limited to a single holder). But if the sale plan initiator is a broker, the scan is not limited to a single holder. A broker may be authorized to create sale plans for a plurality of holders.

The sale plan initiator then views and selects an existing sale plan (step 1106). Typically, the sale plan initiator views only a subset of the data pertaining to each of these sale plans. Only after a sale plan is selected does the sale plan initiator view detailed sale plan data (i.e., documents, parameters, etc.). Additionally, the sale plan initiator has the option of not selecting an existing sale plan and viewing one or more of the other screens described above.

If the sale plan initiator elects to create a sale plan (step 1108-Yes), the controller 260 scans the database 240 to locate holdings data accessible to the sale plan initiator and transfers this data to user computer 30 for display (step 1110). If the sale plan initiator is a holder, the scan is limited to the holdings data of the holder. But if the sale plan initiator is a broker, the scan is not necessarily limited to the holdings of a single holder. As noted above, a broker can be authorized to create sale plans for a plurality of holders. As described above, each holder record includes one or more sub-records for each of the individual holdings of restricted stock. Additionally, the sub-record contains links to one or more brokers authorized to act on behalf of a corresponding holder. Step 1110 includes locating such sub-records that designate a particular sale plan initiator.

The sale plan initiator then views and selects a holding to be the subject of a sale plan (step 1112). Again, the sale plan initiator has the option of not selecting a holding and viewing one or more of the other screens described above.

But if a selection is made, the controller 260 creates and transfers a sale plan ID, which is a unique identifier used when subsequently referencing the sale plan (step 1114). Step 1114 also preferably includes the creation of an entry in the database 240 corresponding to the sale plan ID.

Following steps 1106 or 1114, a sale plan template is displayed on user computer 30 to the sale plan initiator (step 1116). The sale plan template may be copied from an existing sale plan or based upon a selected holding.

The sale plan initiator can then add or update sale plan parameters in the sale plan template via internet browser 340 (step 1118). Sale plans must specify the start and stop dates of the sale plan; the total number of shares to delegend and sell under the sale plan or the total dollar value of shares to delegend and sell under the sale plan; and the frequency with which to execute individual sales while the sale plan is in effect. Sale plans can also specify simplistic or complex sale plan limits. For example, a sale plan can specify that with respect to a given sale, five thousand shares are to be sold if the share price reaches a defined dollar amount, but that ten thousand shares are to be sold if the share price reaches an additional, higher defined dollar amount. The sale plan can also specify whether an unfulfilled sale under a sale plan should carry over to another day. For example, if a sale plan specifies that with respect to a given sale, ten thousand shares are to be sold if the share price is greater than a defined dollar amount, but the share price never reaches this level on the date upon which the given sale is scheduled to take place, the sale may or may not carry over to another day. This is an option preferably specified in step 1118.

The sale plan initiator can then add and/or update any documents typically required for the sale plan (step 1120). Such documents may include a seller's representation letter, a Rule 144 Form, and a sale plan contract and addendum. A sale plan initiator may have preferred templates. The sale plan initiator can retrieve templates for the seller's representation letter, the Rule 144 Form, and the sale plan contract and addendum from database 240 using Internet browser 340 and web pages from Website 230. The sale plan initiator also has the option of importing templates from a different source. In either case, the sale plan initiator can view and edit the template using a compatible word processor. Step 1120 is where such a template would be selected and modified by the sale plan initiator to create or partially create a sale plan contract. Note that a contract template typically includes language that changes only in minor ways from one sale plan to the next. The addendum typically specifies parameters relevant only to the current sale plan being created (e.g., sale dates).

The sale plan initiator then reviews the sale plan (i.e., sale plan parameters and documentation) (step 1122). If the sale plan initiator elects to release the sale plan (step 1124-Yes), the controller 260 updates the entry in the database 240 corresponding to the sale plan ID with parameters, documents, and any other information added or updated by the sale plan initiator (step 1126).

The update also includes the controller 260 modifying the status of the sale plan to indicate that another entity is now responsible for advancing the sale plan. Specifically, if the sale plan initiator is a broker, the status of the sale plan will subsequently indicate that the holder is responsible for advancing the sale plan (i.e., the sale plan has been released to the holder, but is still in the first stage). But if the sale plan initiator is a holder, the status of the sale plan will subsequently indicate that the broker is responsible for advancing the sale plan (i.e., the sale plan has been released to the broker and is in the second stage). As a result of this aspect of the update, the entry in the database 240 corresponding to the sale plan will become an action for either the broker or the holder. For example, if the sale plan initiator is a broker, the entry will be displayed as an action in step 458 of FIG. 4D as described above.

Similarly, if the sale plan initiator is a broker, the status of the sale plan will also subsequently indicate that the sale plan is still in the first stage of the process. But if the sale plan initiator is a holder, the status of the sale plan will also subsequently indicate that the sale plan is in the second stage of the process.

The controller 260, furthermore, sends notifications to the entities involved in the sale plan (step 1128). For example, if the sale plan initiator is a broker, the holder of the restricted stock that is the subject of the sale plan receives some form of electronic notification (e.g., an email).

If the sale plan initiator does not elect to release the sale plan (step 1124-No), the sale plan initiator is given the option to enter status comments (1130). The status comments can include any information that might enable the sale plan initiator to subsequently release the sale plan. For example, the sale plan initiator could leave a note reminding the sale plan initiator to confirm some aspect of the sale plan. The controller 260 then updates the sale plan (i.e., the entry in the database 240 corresponding to the sale plan ID) with parameters, documents, and any other information added or updated by the sale plan initiator, updates the status of the sale plan, and saves the status comments in relation to the entry (step 1132). If the sale plan was just created as described above in steps 1108-1114, the sale plan is now an existing sale plan that will be retrieved next time step 1104 is executed for the sale plan initiator.

As indicated above, if the sale plan initiator is a broker, a holder must review the sale plan released by the sale plan initiator. The steps taken by the holder in this situation are essentially the same as those described above in connection with FIG. 11. Differences include the holder viewing an existing sale plan released by a broker instead of creating a sale plan or reviewing an existing sale plan previously created by the holder. An existing sale plan created by a broker will be retrieved by the controller 260 in step 1104 for the holder because of status changes made during step 1126. Additionally, the holder can choose to not release the sale plan (step 1124-No) and require in step 1130 that the broker take additional steps with respect to the sale plan before the holder will review the sale plan again. If so, the controller 260 updates the status of the sale plan so that it will subsequently be retrieved for the broker during execution of step 1104. And importantly, when the holder is prepared to release the sale plan, the holder will include some form of execution that binds the holder to the sale plan contract. For example, the holder might include a digital signature or a scanned copy of the sale plan contract after off-line execution.

FIG. 12 illustrates processing steps included in a preferred embodiment of the present invention that represent the second stage (and fourth stage) of this process. As described above with reference to steps 500-504 a broker signs-on to server 20 using a user name and password combination and receives a display of action data.

In addition to the options described above with reference to FIGS. 5A-5B, the broker can process a sale plan released to the second stage by a holder (step 1202). If the broker elects to process such a sale plan (step 1202-Yes), the controller 260 scans the database 240 to locate all such sale plans, which also includes sales plans in the second stage that the broker began processing but did not release (step 1204).

The broker then views and selects a sale plan (step 1206). Typically, the broker views only a subset of the data pertaining to each of these sale plans. Only after a sale plan is selected does the broker view detailed sale plan data. Additionally, the sale plan initiator has the option of not selecting an existing sale plan and viewing one or more of the other screens described above.

Following a sale plan selection in step 1206, the sale plan parameters, documents, and other information are displayed to and reviewed by the broker (step 1208). Following the review, the broker can accept the sale plan (step 1210). If the broker elects to accept the sale plan (step 1210-Yes), the controller 260 updates the status of the sale plan to accepted (step 1212) and sends notifications—preferably to the holder and the corporate counselor (step 1214). But if the sale plan has only reached the second stage of the process, instead of the fourth stage, the broker will not accept the sale plan. This step (1210-Yes) is taken only after a corporate counselor has reviewed the sale plan during the third stage. The ramifications of accepting the sale plan are discussed below in the connection with the fourth stage.

The broker can also release the sale plan (step 1216) to the third stage or another individual within the broker entity so that the sale plan remains in the second stage (or the fourth stage). If the broker elects to release the sale plan (step 1216-Yes), the broker is given the option to designate a reviewer within the broker entity (steps 1216-Yes, 1218). Often, more than one person must review a sale plan before it is released to the next stage or accepted. For example, a broker might have a junior employee review the sale plan before a more senior employee provides a final review of the sale plan prior to acceptance. The present invention is designed to allow the broker to specify in advance the names and order of the reviewers within the organization. Thus, when a sale plan is released to the second or fourth stage (i.e., to the broker), a designated person within the broker entity may be given the task of reviewing the sale plan first. Further, at this step of the process, controller 260 can automatically include the name and email address of the next person within the broker to review the sale plan. If the final reviewer has been reached, no such information is included. Additionally, the broker has the option of altering this information as needed (e.g., change the next person within the broker entity to review the sale plan).

Following either step 1218-No or step 1220, the controller 260 updates the sale plan status (step 1222). The sale plan status subsequently indicates that either the corporate counselor or another individual within the broker entity is responsible for advancing the sale plan. As a result of the update, the entry in the database 240 corresponding to the sale plan will become an action for the corporate counselor of the issuer of the restricted stock that is the subject of the sale plan or a designated individual within the broker entity. The entry might, therefore, be displayed as an action for the corporate counselor in step 604 of FIG. 6A as described above. Similarly, the status of the sale plan will also subsequently indicate that the sale plan is now in the third stage of the process or still in the second stage of the process depending on whether the corporate counselor or another individual within the broker entity is responsible for advancing the sale plan.

The controller 260, furthermore, sends notifications to the entities involved in the sale plan (step 1224). In particular, some form of electronic notifications (e.g., an email) are preferably sent to the holder and the broker or the corporate counselor.

If the broker does not elect to release the sale plan (step 1216-No), the broker is given the option to enter status comments (1226). The status comments can include any information that might enable the broker to subsequently release the sale plan. The controller 260 then updates the status of the sale plan (i.e., the entry in the database 240 corresponding to the sale plan) and saves the status comments for subsequent review (step 1228). As a result of steps 1216, 1226, and 1228, the holder may be required to take make changes to the sale plan to address any issues identified by the broker (and reflected in the status comments). In other words, the broker can send the sale plan back to the first stage for modification by the holder. The broker can also leave the sale plan in the second stage (or in the fourth stage) and finish reviewing the sale plan at a later time.

FIG. 13 illustrates processing steps included in a preferred embodiment of the present invention that represent the third stage of this process. As described above with reference to steps 600-604 a corporate counselor signs-on to server 20 using a user name and password combination and receives a display of action data.

In addition to the options described above with reference to FIGS. 6A-6C, the corporate counselor can process a sale plan released to the third stage by a broker (step 1302). If the corporate counselor elects to process such a sale plan (step 1302-Yes), the controller 260 scans the database 240 to locate all such sale plans, which also includes sales plans in the third stage that the corporate counselor began processing but did not release (step 1304).

The corporate counselor then views and selects a sale plan (step 1306). Typically, the corporate counselor views only a subset of the data pertaining to each of these sale plans. Only after a sale plan is selected does the corporate counselor view detailed sale plan data. Additionally, the corporate counselor has the option of not selecting an existing sale plan and viewing one or more of the other screens described above.

Following a sale plan selection in step 1306, the sale plan parameters, documents, and other information are displayed to and reviewed by the corporate counselor (step 1308). In particular, the corporate counselor determines whether the sale plan is in compliance with stated policies of the issuer of the restricted stock or whether the issuer is taking or about to take material actions (i.e., actions that affect such sale plans).

If the corporate counselor does not elect to release the sale plan (step 1310-No), the corporate counselor is given the option to enter status comments (1316). The status comments can include any information that might enable the corporate counselor to subsequently release the sale plan or indicate to the broker and holder that the sale plan is not in compliance with the stated policies of the issuer or that the issuer is taking or about to take material actions. The controller 260 then updates the status of the sale plan (i.e., the entry in the database 240 corresponding to the sale plan) and saves the status comments for subsequent review (step 1318). As a result of steps 1310, 1316, and 1318, the holder may be required to make changes to the sale plan to address any issues identified by the corporate counselor (and reflected in the status comments). In other words, the corporate counselor can send the sale plan back to the first or second stage for modification by the holder or broker respectively. The corporate counselor can also leave the sale plan in the third stage and finish reviewing the sale plan at a later time.

If the corporate counselor determines that the sale plan is in compliance with stated policies of the issuer of the restricted stock and elects to release the sale plan (step 1310-Yes), the controller 260 updates the sale plan status (step 1312). The sale plan status subsequently indicates that the sale plan is now in the fourth stage and that a broker must review the sale plan to advance it to a next stage. More specifically, the entry will be displayed as an action for the broker in step 504 of FIG. 5A as described above.

As described above, a transfer agent will remove legends from a restricted stock certificate and deliver a clean stock certificate to a broker. This step is taken by the transfer agent after issuance of an opinion regarding the restricted stock certificate by a corporate counselor on behalf of the issuer of the restricted stock certificate. In anticipation of the individual sales specified in a sale plan, a corporate counselor might issue an opinion regarding the individual sales after releasing the sale plan and direct the transfer agent to initiate the process of removing legends from one or more restricted stock certificates.

Returning to FIG. 13, the controller 260, furthermore, sends notifications to the entities involved in the sale plan (step 1314). In particular, some form of electronic notifications (e.g., an email) are preferably sent to the broker and holder.

As indicated above, the fourth stage of the process is completed by a broker. The steps take are essentially identical to those described above in connection with FIG. 12. As noted above, the broker has the option to accept the sale plan during the fourth stage (step 1210-Yes). If so, the sale plan is executed by the controller 260 as described in more detail below (i.e., the sale plan is released to the fifth stage). Depending on the parameters of the sale plan, execution can begin almost immediately. Because of the importance of this step, a specific individual within the broker entity is typically required to accept the sale plan. The broker can also send the sale plan back to the first stage for modification by the holder in view of the corporate counselor's status comments.

If the sale plan is released to the fifth stage by the broker, the controller 260 subsequently initiates each sale specified in the sale plan on the dates specified in the sale plan. The initiation preferably includes the creation of a pending action (including an action ID) in database 240. The pending action preferably includes all of the information that would otherwise be produced by the holder and the controller 260 in steps 400-454 as described in detail above. This information is extracted from the entry in the database 240 corresponding to the sale plan.

The pending actions are preferably created only when specified by the sale plan. In particular, the controller 260 preferably scans the database 240 periodically for sale plans that call for the creation of a pending action. More specifically, the controller 260 preferably scans for daily sale plans (i.e., sale plans that call for the creation of pending actions daily) that are still active (i.e., the current date is still within the start and stop dates specified by sale plan parameters). For each such sale plan, the controller 260 creates a pending action. The controller 260 also scans for weekly plans (i.e., sale plans that call for the creation of pending actions weekly), monthly sale plans (i.e., sale plans that call for the creation of pending actions monthly), quarterly sale plans (i.e., sale plans that call for the creation of pending actions quarterly), and annual sale plans (i.e., sale plans that call for the creation of pending actions annually). Such sale plans may be active, but not call for the creation of a pending entry on a given day. For example, a weekly sale plan may specify sales once per week and have a start date that falls on a Tuesday such that subsequent sales occur only on Tuesdays. In alternate embodiments, sale plans may call for sales to occur on an hourly or some other such basis. In these embodiments, the controller 260 scans the database 240 often enough to trigger such sales in a timely fashion.

And as indicated above, a sale plan can also specify whether an unfulfilled sale under a sale plan should carry over to another day. In other words, the controller 260 might create a pending action for a given sale under a sale plan every day following an initial pending action until the sale is complete even though the sale plan would not otherwise call for the daily creation of pending actions.

To facilitate this aspect of the invention, a broker preferably updates the database 240 after each pending action is created to reflect the details of actual sales. In particular, the broker enters the number of shares sold and the price at which each share is sold. As noted above, sale plan parameters include the maximum number of shares to be sold under a sale plan and/or the maximum dollar value of sales under a sale plan. The information entered by the broker, therefore, is used by the controller 260 to determine whether any of these limitations have been met.

When one or more of the limitations specified in a sale plan has been met or the stop date passes, the controller 260 terminates processing of the sale plan. It is typically the obligation of a broker to update the status of the sale plan to indicate that it is complete.

While the present invention has been described with reference to the preferred embodiments, those skilled in the art will recognize that numerous variations and modifications may be made without departing from the scope of the present invention.

For example, the present invention is compatible with external systems that provide stock related information (e.g., share prices or P/E ratios of a given stock) or provide electronic trade placement services. When such external systems are used, the holder is able to specify complex sale plan parameters. For example, the holder can specify that if the price of a given share is below a first value, a first number of shares are sold, but if the share prices exceed a second value, a second number of share are sold. Another, more complex example concerns P/E ratios of a given stock and a basket of other stocks. In this example, the holder can specify that if the P/E ratio of a given stock relative to the P/E ratio of a specified basket of stocks reaches a certain level, a specified number of shares are sold. These types of sale plan parameters are often too complicated for brokers to execute. Accordingly, the controller 260 interfaces with these external systems to request the execution of a sale when the controller 260 determines that the sale parameters have been met.

Moreover, while a preferred embodiment regarding the system architecture of the present invention has been disclosed in connection with FIG. 1, it will be understood that in view of the foregoing description, other system architectures that can carry out one or more of the methods of the present invention may also be available, and all such other system architectures are contemplated to be within the scope of the present invention. Accordingly, it should be clearly understood that the embodiments of the invention described above are not intended as limitations on the scope of the invention, which is defined only by the claims that are now or may later be presented.

What is claimed is:

1. A computer-implemented method to create and execute a restricted stock sale plan, comprising
maintaining restricted stock information corresponding to a restricted stock, said restricted stock information accessible via a network by a sale plan initiator, a holder, a broker, and a counselor;
providing a sale plan template to the sale plan initiator via the network in response to receiving from said sale plan initiator via said network a request to create said sale plan, said sale plan template including information extracted from the restricted stock information;
when the sale plan initiator is the broker
making the sale plan available to the holder via the network in response to receiving said sale plan from the sale plan initiator via the network, said sale plan having been updated by the sale plan initiator to call for action by the holder;
providing the sale plan to the holder via the network in response to receiving from said holder via said network a request for said sale plan;
making the sale plan available to the broker via the network in response to receiving from one of the sale plan initiator and the holder via said network said sale plan, said sale plan having been updated by said one of the sale plan initiator and the holder to include sale plan documentation and sale plan parameters and to call for action by the broker;
providing the sale plan to the broker via the network in response to receiving from said broker via said network a request for said sale plan;
making the sale plan available to the counselor via the network in response to receiving from the broker via said network said sale plan, said sale plan having been reviewed and updated by said broker to call for action by the counselor;
providing the sale plan to the counselor via the network in response to receiving from said counselor via said network a request for said sale plan;
making the sale plan available to the broker via the network in response to receiving from the counselor via said network said sale plan, said sale plan having been reviewed and updated by said counselor to call for action by the broker; and
initiating a delegending process for each of a specified number of sales concerning the restricted stock in accordance with the sale plan parameters of the sale plan in response to receiving from the broker via the network said sale plan, said sale plan having been updated by said broker to call for the delegending process.

2. The computer-implemented method of claim 1, wherein said initiating step includes
creating and storing a data record for the each of the specified number of sales, said data record including a portion of said restricted stock information, said data record stored in relation to the broker.

3. The computer-implemented method of claim 1, including
periodically scanning a database for a sale plan calling for initiation of the delegending process for a corresponding restricted stock; and
creating and storing in the database a data record that includes data relating to the delegending process, said data record including a cross-reference to the sale plan.

4. The computer-implemented method of claim 1, further comprising
updating the sale plan by the holder to call for additional action by the sale plan initiator, said sale plan subsequently being subject to an additional review by said holder.

5. The computer-implemented method of claim 1, further comprising
updating the sale plan by the broker to call for additional action by the holder, said sale plan subsequently being subject to an additional review by said broker.

6. The computer-implemented method of claim 1, further comprising
updating the sale plan by the counselor to call for additional action by the holder and the broker, said sale plan subsequently being subject to an additional review by said counselor.

7. A computer program product for use in conjunction with a computer system, the computer program product comprising a computer readable storage medium and a computer program mechanism embedded therein, the computer program mechanism comprising
instructions that maintain restricted stock information corresponding to a restricted stock, said restricted stock information accessible via a network by a sale plan initiator, a holder, a broker, and a counselor;
instructions that provide a sale plan template to the sale plan initiator via the network in response to receiving from said sale plan initiator via said network a request to create said sale plan, said sale plan template including information extracted from the restricted stock information;
when the sale plan initiator is the broker
instructions that make the sale plan available to the holder via the network in response to receiving said sale plan from the sale plan initiator via the network, said sale plan having been updated by the sale plan initiator to call for action by the holder;
instructions that provide the sale plan to the holder via the network in response to receiving from said holder via said network a request for said sale plan;
instructions that make the sale plan available to the broker via the network in response to receiving from one of the sale plan initiator and the holder via said network said sale plan, said sale plan having been updated by said one of the sale plan initiator and the holder to include sale plan documentation and sale plan parameters and to call for action by the broker;
instructions that provide the sale plan to the broker via the network in response to receiving from said broker via said network a request for said sale plan;
instructions that make the sale plan available to the counselor via the network in response to receiving from the broker via said network said sale plan, said sale plan having been reviewed and updated by said broker to call for action by the counselor;
instructions that provide the sale plan to the counselor via the network in response to receiving from said counselor via said network a request for said sale plan;
instructions that make the sale plan available to the broker via the network in response to receiving from the counselor via said network said sale plan, said sale plan having been reviewed and updated by said counselor to call for action by the broker; and
instructions that initiate a delegending process for each of a specified number of sales concerning the restricted stock in accordance with the sale plan parameters of the sale plan in response to receiving from the broker via the network said sale plan, said sale plan having been updated by said broker to call for the delegending process.

8. The computer program product of claim 7, wherein said initiating step includes
instructions that create and store a data record for the each of the specified number of sales, said data record including a portion of said restricted stock information, said data record stored in relation to the broker.

9. The computer program product of claim 7, including
instructions that periodically scan a database for a sale plan calling for initiation of the delegending process for a corresponding restricted stock; and
instructions that create and store in the database a data record that includes data relating to the delegending process, said data record including a cross-reference to the sale plan.

10. The computer program product of claim 7, further comprising
instructions that update the sale plan by the holder to call for additional action by the sale plan initiator, said sale plan subsequently being subject to an additional review by said holder.

11. The computer program product of claim 7, further comprising
instructions that update the sale plan by the broker to call for additional action by the holder, said sale plan subsequently being subject to an additional review by said broker.

12. The computer program product of claim 7, further comprising
instructions that update the sale plan by the counselor to call for additional action by the holder and the broker, said sale plan subsequently being subject to an additional review by said counselor.

13. A computer system to create and execute a sale plan corresponding to a restricted stock, comprising
a memory to store instructions and data;
a processor to execute the instructions stored in the memory;
the memory storing
instructions that maintain restricted stock information corresponding to a restricted stock, said restricted stock information accessible via a network by a sale plan initiator, a holder, a broker, and a counselor;
instructions that provide a sale plan template to the sale plan initiator via the network in response to receiving from said sale plan initiator via said network a request to create said sale plan, said sale plan template including information extracted from the restricted stock information;
when the sale plan initiator is the broker
instructions that make the sale plan available to the holder via the network in response to receiving said sale plan from the sale plan initiator via the network, said sale plan having been updated by the sale plan initiator to call for action by the holder;
instructions that provide the sale plan to the holder via the network in response to receiving from said holder via said network a request for said sale plan;
instructions that make the sale plan available to the broker via the network in response to receiving from one of the sale plan initiator and the holder via said network said sale plan, said sale plan having been updated by said one of the sale plan initiator and the holder to include sale plan documentation and sale plan parameters and to call for action by the broker;
instructions that provide the sale plan to the broker via the network in response to receiving from said broker via said network a request for said sale plan;
instructions that make the sale plan available to the counselor via the network in response to receiving from the broker via said network said sale plan, said sale plan having been reviewed and updated by said broker to call for action by the counselor;
instructions that provide the sale plan to the counselor via the network in response to receiving from said counselor via said network a request for said sale plan;
instructions that make the sale plan available to the broker via the network in response to receiving from the counselor via said network said sale plan, said sale plan having been reviewed and updated by said counselor to call for action by the broker; and
instructions that initiate a delegending process for each of a specified number of sales concerning the restricted stock in accordance with the sale plan parameters of the sale plan in response to receiving from the broker via the network said sale plan, said sale plan having been updated by said broker to call for the delegending process.

14. The computer system of claim 13, wherein said initiating step includes
instructions that create and store a data record for the each of the specified number of sales, said data record including a portion of said restricted stock information, said data record stored in relation to the broker.

15. The computer system of claim 13, including
instructions that periodically scan the memory for a sale plan calling for initiation of the delegending process for a corresponding restricted stock; and
instructions that create and store in the memory a data record that includes data relating to the delegending process, said data record including a cross-reference to the sale plan.

16. The computer system of claim 13, further comprising
instructions that update the sale plan by the holder to call for additional action by the sale plan initiator, said sale plan subsequently being subject to an additional review by said holder.

17. The computer system of claim 13, further comprising
instructions that update the sale plan by the broker to call for additional action by the holder, said sale plan subsequently being subject to an additional review by said broker.

18. The computer system of claim 13, further comprising
instructions that update the sale plan by the counselor to call for additional action by the holder and the broker, said sale plan subsequently being subject to an additional review by said counselor.

19. A computer-implemented method to create and execute a restricted stock sale plan, comprising
a first stage in which a process for creating and executing a sale plan regarding a restricted stock is initiated by one of a broker and the broker and a holder, said first stage resulting in a sale plan contract, a set of sale plan parameters, and a release of the process to a second stage;
the second stage in which the sale plan contract and the set of sale plan parameters are reviewed by the broker, said broker able to return the process to the first stage and alternatively release the process to a third stage;
the third stage in which the sale plan contract and the set of sale plan parameters are reviewed by a corporate counselor for issues concerning an issuer of the restricted stock, said corporate counselor able to return the process to the first stage and alternatively release the process to a fourth stage;
the fourth stage in which the sale plan contract and the set of sale plan parameters are further reviewed by the broker, said broker able to return the process to the first stage and alternatively accept said sale plan and release the process to a fifth stage; and
the fifth stage in which a controller initiates a delegending process for each of a specified number of sales concerning the restricted stock in accordance with the sale plan parameters of the sale plan.

20. The computer-implemented method of claim 19, wherein the fifth stage includes the controller
periodically scanning a database for a sale plan calling for initiation of the delegending process for a corresponding restricted stock; and
creating and storing a data record that includes data relating to the delegending process, said data record including a cross-reference to the sale plan.

21. A computer program product for use in conjunction with a computer system, the computer program product comprising a computer readable storage medium and a computer program mechanism embedded therein, the computer program mechanism comprising
instructions for execution of a first stage in which a process for creating and executing a sale plan regarding a restricted stock is initiated by one of a broker and the broker and a holder, said first stage resulting in a sale plan contract, a set of sale plan parameters, and a release of the process to a second stage;
instructions for execution of the second stage in which the sale plan contract and the set of sale plan parameters are reviewed by the broker, said broker able to return the process to the first stage and alternatively release the process to a third stage;
instructions for execution of the third stage in which the sale plan contract and the set of sale plan parameters are reviewed by a corporate counselor for issues concerning an issuer of the restricted stock, said corporate counselor able to return the process to the first stage and alternatively release the process to a fourth stage;
instructions for execution of the fourth stage in which the sale plan contract and the set of sale plan parameters are further reviewed by the broker, said broker able to return the process to the first stage and alternatively accept said sale plan and release the process to a fifth stage; and
instructions for execution of the fifth stage in which a controller initiates a delegending process for each of a specified number of sales concerning the restricted stock in accordance with the sale plan parameters of the sale plan.

22. The computer program product of claim 21, wherein the instructions for the fifth stage include
instructions by which the controller periodically scans the memory for a sale plan calling for initiation of the delegending process for a corresponding restricted stock; and
instructions by which the controller creates and stores in the memory a data record that includes data relating to the delegending process, said data record including a cross-reference to the sale plan.

23. A computer system to create and execute a sale plan corresponding to a restricted stock, comprising
a memory to store instructions and data;
a processor to execute the instructions stored in the memory;
the memory storing
instructions for execution of a first stage in which a process for creating and executing a sale plan regarding a restricted stock is initiated by one of a broker and the broker and a holder, said first stage resulting in a sale plan contract, a set of sale plan parameters, and a release of the process to a second stage;
instructions for execution of the second stage in which the sale plan contract and the set of sale plan parameters are reviewed by the broker, said broker able to return the process to the first stage and alternatively release the process to a third stage;
instructions for execution of the third stage in which the sale plan contract and the set of sale plan parameters are reviewed by a corporate counselor for issues concerning an issuer of the restricted stock, said corporate counselor able to return the process to the first stage and alternatively release the process to a fourth stage;
instructions for execution of the fourth stage in which the sale plan contract and the set of sale plan parameters are further reviewed by the broker, said broker able to return the process to the first stage and alternatively accept said sale plan and release the process to a fifth stage; and
instructions for execution of the fifth stage in which a controller initiates a delegending process for each of a specified number of sales concerning the restricted stock in accordance with the sale plan parameters of the sale plan.

24. The computer system of claim 31, wherein the instructions for the fifth stage include
instructions by which the controller periodically scans the memory for a sale plan calling for initiation of the delegending process for a corresponding restricted stock; and
instructions by which the controller creates and stores in the memory a data record that includes data relating to the delegending process, said data record including a cross-reference to the sale plan.

25. A computer-implemented system for creating, modifying, and executing a restricted stock sale plan, comprising:
a plurality of processing stages, each processing stage comprising a plurality of parameters defining operational aspects of the processing stage, wherein the parameters comprise:
a first parameter that defines a set of entities authorized to act with respect to the restricted stock sale plan during the processing stage, the set of entities comprising one or more entities;
a second parameter that defines a set of actions that the set of entities is authorized to perform during the processing stage, the set of actions comprising one or more actions; and
a third parameter that defines a set of processing stages to which the restricted stock sale plan may be released at the discretion of a member of the set of entities, the set of processing stages comprising one or more processing stages.

26. The computer-implemented system of claim 1, wherein the plurality of processing stages includes
a sale plan initiator stage in which
the set of entities comprises a sale plan initiator;
the set of actions comprises a creation of a sale plan contract and a set of sale plan parameters; and
the set of processing stages comprises an initial broker approval stage.

27. The computer-implemented system of claim 1, wherein the plurality of processing stages includes
an initial broker approval stage in which
the set of entities comprises a broker;
the set of actions comprises a review of a sale plan contract and a set of sale plan parameters produced by a sale plan initiator stage; and
the set of processing stages comprises the sale plan initiator stage and a counselor approval stage.

28. The computer-implemented system of claim 1, wherein the plurality of processing stages includes
a counselor approval stage in which
the set of entities comprises a counselor;
the set of actions comprises a review of a sale plan contract and a set of sale plan parameters forwarded from an initial broker approval stage; and
the set of processing stages comprises a sale plan initiator stage and a final broker approval stage.

29. The computer-implemented system of claim 1, wherein the plurality of processing stages includes
a final broker approval stage in which
the set of entities comprises a broker;
the set of actions comprises a final review of a sale plan contract and a set of sale plan parameters forwarded from a counselor approval stage; and
the set of processing stages comprises a sale plan initiator stage.

30. The computer-implemented system of claim 1, wherein the plurality of processing stages includes
a controller execution stage in which
the set of entities comprises a controller; and
the set of actions comprises initiation of a delegending process for each sale specified in a sale plan and a set of sale plan parameters, said sale plan and said set of sale plan parameters forwarded from a final broker approval stage.
